(19) United States
(12) Patent Application Publication
(10) Pub. No.: US 2003/0098814 A1
(43) Pub. Date: May 29, 2003

(54) Multiband antenna formed of superimposed compressed loops

(76) Inventors: Walter John Keller III, Half Moon Bay, CA (US); Osbaldo Jose Romero, San Francisco, CA (US); Jesada Sivaraks, Pacifica, CA (US)

Correspondence Address: DAVID E. LOVEJOY, REG. NO. 22,748, 102 REED RANCH ROAD, TIBURON, CA, 94920-2025, US

(21) Appl. No.: 09/995,478

(22) Filed: Nov. 27, 2001

Related U.S. Application Data
(60) Provisional application No. 60/339,263, filed on Nov. 9, 2001.

(51) Int. Cl. H01Q 11/12; H01Q 21/00

(52) U.S. Cl. 343/742; 343/867

(57) ABSTRACT

A compressed multiple band loop antenna that has multiple superimposed compressed loops. Each compressed loop is formed from numerous segments arrayed in multiple diverse directions so that the enclosed area of that loop and the overall size of the antenna are decreased. Multiple loops are arrayed and superimposed to provide multiple frequency bands of operation and are used to broaden the useful bandwidth of individual-bands. The small size of the compressed antenna facilitates its use in small mobile communications devices requiring internal antennas that operate in close proximity to conductive surfaces. Multiple loops are arrayed in several configurations that include nested and non-nested loops as well as closely located and spatially separated superimposed loops.

### BACKGROUND OF THE INVENTION

The present invention relates to the field of communication devices that communicate using radiation of electromagnetic energy and particularly relates to antennas and antenna connections for such communication devices, particularly for communication devices carried by persons or otherwise benefitting from small-sized antennas.

Communication Antennas Generally. In communication devices and other electronic devices, antennas are elements having the primary function of transferring energy to or from the electronic device through radiation. Energy is transferred from the electronic device into space or is received from space into the electronic device. A transmitting antenna is a structure that forms a transition between guided waves contained within the electronic device and space waves traveling in space external to the electronic device. A receiving antenna is a structure that forms a transition between space waves traveling external to the electronic device and guided waves contained within the electronic device. Often the same antenna operates both to receive and transmit radiation energy.

J. D. Kraus “Electromagnetics”, 4th ed., McGraw-Hill, New York 1991, Chapter 15 Antennas and Radiation indicates that antennas are designed to radiate (or receive) energy. Antennas act as the transition between space and circuitry. They convert photons to electrons or vice versa. Regardless of antenna type, all involve the same basic principal that radiation is produced by accelerated (or decelerated) charge. The basic equation of radiation may be expressed as follows:

IL=Qν(Am/s)

where:

I=time changing current (A/s)

L=length of current element (m)

Q=charge (C)

ν=time-change of velocity which equals the acceleration of the charge (m/s)

The radiation is perpendicular to the direction of acceleration and the radiated power is proportional to the square of IL or Qν.

A radiated wave from or to an antenna is distributed in space in many spatial directions. The time it takes for the spatial wave to travel over a distance r into space between an antenna point, Pₐ, at the antenna and a space point, P, at a distance r from the antenna point is r/c seconds where r=distance (meters) and c=free space velocity of light (=3×10⁸ meters/sec). The quantity r/c is the propagation time for the radiation wave between the antenna point Pₐ and the space point Pₛ.

An analysis of the radiation at a point P at a time t, at a distance r caused by an electrical current I in any infinitesimally short segment at point Pₐ of an antenna is a function of the electrical current that occurred at an earlier time [t−r/c] in that short antenna segment. The time [t−r/c] is a retardation time that accounts for the time it takes to propagate a wave from the antenna point Pₐ at the antenna segment over the distance r to the space point P.

For simple antenna geometries, antennas are typically analyzed as a connection of infinitesimally short radiating antenna segments and the accumulated effect of radiation from the antenna as a whole is analyzed by accumulating the radiation effects of each antenna segment. The radiation at different distances from each antenna segment, such as at any space point Pₛ, is determined by accumulating the effects from each infinitesimally short antenna segment at point Pₐ of the antenna at the space point P. The analysis at each space point P is mathematically complex because the parameters for each segment of the antenna may be different. For example, among other parameters, the frequency phase of the electrical current in each antenna segment and distance from each antenna segment to the space point P can be different.

A resonant frequency, f, of an antenna can have many different values as a function, for example, of dielectric constant of material surrounding antenna, the type of antenna and the speed of light.

In general, wave-length, λ, is given by λ=c/f=cT where c=velocity of light (=3×10⁸ meters/sec), f=frequency (cycles/sec), T=1/f=period (sec). Typically, the antenna dimensions such as antenna length, Aₗ, relate to the radiation wavelength λ of the antenna. The electrical impedance properties of an antenna are allocated between a radiation resistance, Rᵣ, and an ohmic resistance, Rₒ. The higher the ratio of the radiation resistance, Rᵣ, to the ohmic resistance, Rₒ the greater the radiation efficiency of the antenna.

Antennas are frequently analyzed with respect to the near field and the far field where the far field is at locations of space points P where the amplitude relationships of the fields approach a fixed relationship and the relative angular distribution of the field becomes independent of the distance from the antenna.

Antenna Types. A number of different antenna types are well known and include, for example, loop antennas, small loop antennas, dipole antennas, stub antennas, conical antennas, helical antennas and spiral antennas. Such antenna types have often been based on simple geometric shapes. For example, antenna designs have been based on lines, planes, circles, triangles, squares, ellipses, rectangles, hemispheres and paraboloids. The two most basic types of electromagnetic field radiators are the magnetic dipole and the electric dipole. Small antennas, including loop antennas, often have the property that radiation resistance, Rᵣ, of the antenna decreases sharply when the antenna length is shortened. Small loops and short dipoles typically exhibit radiation patterns of ½λ and ¼λ, respectively. Ohmic losses due to the ohmic resistance, Rₒ are minimized using impedance matching networks. Although impedance matched small circular loop antennas can exhibit 50% to 85% efficiencies, their bandwidths have been narrow, with very high Q, for example, Q>50. Q is often defined as (transmitted or received frequency)/(3 dB bandwidth).

An antenna goes into resonance where the impedance of the antenna is purely resistive and the reactive component goes to 0. Impedance is a complex number consisting of real resistance and imaginary reactance components. A matching network can be used to force resonance by eliminating the reactive component of impedance for a particular frequency.

Electric Dipole. A linear antenna is often considered as a large number of very short conductor elements connected in series. For purpose of explanation, the minimum element of linear antenna is a short electric dipole (see FIG. 6). The electric dipole is “short” in the sense that its physical length (L) is much smaller than the wavelength (λ) of the signal exciting it, that is, L/λ<<1. For purpose of analysis, the two ends of a electric dipole are considered plates with capacitive loading. These plates and the L<<λ condition, provide a basis for assuming a uniform electric current I along the entire length of the electric dipole. Also, the electric dipole is assumed to be energized by a balanced transmission line, is assumed to have negligible radiation from the end plates, and is assumed to have a very thin diameter, d, that is, d<<L, such that the electric dipole consists simply of a thin conductor of length L carrying a uniform current I with point charges +q and −q at the ends. With such an assumed structure, the current I and charge q are related by:

$$\frac{ⅆ q}{ⅆ t} = I$$

For any point Pₐ on the electric dipole, the electric and magnetic fields at a point P a distance r from the point Pₐ as a result of the uniform electric current I through the element are represented as vector components in a spherical polar coordinate system having orthogonal XYZ axes (see FIG. 6 and FIG. 7). For an electric dipole normal to the XY plane, the projection of the vector r in the XY-plane has an angle of φ with respect to the XZ plane and an angle of θ from the Z axis normal to the XY plane.

The general equation of both electric (Eᵣ, E_{θ}, E_{φ}) and magnetic (Hᵣ, H_{θ}, H_{φ}) components at point P, offset from point Pₐ by vector r, are as follows:

$${E}_{r} = \frac{[ I ] L cos θ}{2 π ϵ} ( \frac{1}{c {r}^{2}} + \frac{1}{j ω {r}^{2}} )$$

$${E}_{θ} = \frac{[ I ] L sin θ}{2 π ϵ} ( \frac{j ω}{{c}^{2} r} + \frac{1}{c {r}^{2}} + \frac{1}{j ω {r}^{3}} )$$

$${H}_{φ} = \frac{[ I ] L sin θ}{4 π} ( \frac{j ω}{c r} + \frac{1}{{r}^{2}} )$$

where components E_{φ}, Hᵣ, H_{θ} are zero for every P and

where:

[I]=Iₒe^{jω(t-r/c)}

Iₒ=Peak value in time of current (uniform along dipole)

c=Velocity of light

L=Length of dipole

r=Distance from dipole to observation point

Considering the above equations, the 1/r² term is called the induction field or intermediate field component and the 1/r³ term represents the electrostatic field or near field component. These two terms are significant only very close to the dipole and therefore are considered in the near field region of the antenna. For very large r, the 1/r² and 1/r³ terms can be neglected leaving only the 1/r term as being significant. This 1/r terms is called the far field. Consequently, the revised equations of electric and magnetic components at the far field are given as:

$${E}_{r} = 0$$

$${E}_{θ} = \frac{j 60 π [ I ] sin θ}{r} \frac{L}{λ}$$

$${H}_{φ} = \frac{j [ I ] sin θ}{2 r} \frac{L}{λ}$$

Examining the E_{θ} and H_{φ} components in the far field, it can be seen that E_{θ} and H_{φ} are in time phase (with respect to each other) in the far field, and that the field patterns of both are proportional to sin(θ) but independent of φ. The space patterns of those fields are a figure of revolution and doughnut-shaped in three dimensions (see FIG. 10) figure-8 shaped in two dimensions (see FIG. 11). Note that the near field patterns for E_{θ} and H_{φ} are proportional to only sin(θ); so, the shapes of the near field patterns are the same as for the far field and that the Eᵣ component in the near field is proportional to cos θ.

Magnetic Dipole. A magnetic dipole is the dual of the electric dipole and hence an analogy to the electric dipole can be used for purpose of analysis. A magnetic dipole is a short circular antenna element arrayed to form a magnetic field and is represented by a very short loop (see FIG. 8) in the XY-plane. For purpose of analysis, the magnetic dipole conducts an electric current I that causes a magnetic current (Iₘ) normal to the plane of the magnetic dipole. The magnetic current (Iₘ) of the magnetic dipole is the dual of the electric current (I) of the electric dipole. The analysis of the far field pattern of a magnetic dipole (see FIG. 8) is similar to the analysis of the far field pattern of the electric dipole. The only difference is that the electric current I is replaced by a magnetic current Iₘ and the electric field is replaced by magnetic field.

For purpose of analysis, the magnetic dipole is a small loop of area A carrying a uniform in-phase electric current I which is the dual of the electric dipole of length L in the far field. The fields of the short magnetic dipole are the same as the fields of a short electric dipole with the E and H fields and I and Iₘ currents interchanged as follows:

| Small Electric Dipole | Small Magnetic Dipole |
|---|---|
| ${E}_{θ} = \frac{j60 π [ I ] sin θ}{r} \frac{L}{λ}$ | ${H}_{θ} = \frac{j [ {I}_{m} ] sin θ}{240 πr} \frac{L}{λ}$ |
| ${H}_{φ} = \frac{j [ I ] sin θ}{2 r} \frac{L}{λ}$ | ${E}_{φ} = \frac{j [ {I}_{m} ] sin θ}{2 r} \frac{L}{λ}$ |

$where [ {I}_{m} ] = {I}_{mo} {ⅇ}^{j ω ( t - r / c )}$

Considering the equation of far field pattern for magnetic dipole, both H_{θ} and E_{φ} are proportional to sin(θ) but independent of φ. Consequently, the far field pattern of the H_{θ} and E_{φ} components of a magnetic dipole are doughnut-shaped in three dimensions (see FIG. 10) and figure-8 circular in cross section (see FIG. 11).

Applying Relationship Between a Loop and Magnetic Dipole. The relationship between the length of magnetic dipole and a small loop antenna are used to derive the far field pattern equation of a small loop antenna. Accordingly, [Iₘ]L=−j240[I] is used in the above far-field equation for a small magnetic dipole and the far field equations of a small loop antenna are written as:

$${E}_{φ} = \frac{120 {π}^{2} [ I ] sin θ}{r} \frac{A}{{λ}^{2}}$$

$${H}_{θ} = \frac{[ I ] sin θ}{r} \frac{A}{{λ}^{2}}$$

where

[I]=Iₒe^{jω(t-r/c)}

Iₒ=Peak value in time of current (uniform along dipole)

c=Velocity of light

A=Area of loop antenna

r=Distance from Loop to observation point

The above far field equations are good approximations for loops up to 0.1 wavelength in diameter and dipoles up to 0.1 wavelength long. A comparison of far fields between small electric dipoles and small loop antennas are given in the following table:

| Field | Electric dipole | Loop Antenna |
|---|---|---|
| Electric component | ${E}_{θ} = \frac{j60 π [ I ] sin θ}{r} \frac{L}{λ}$ | ${E}_{φ} = \frac{120 {π}^{2} [ I ] sin θ}{r} \frac{A}{{λ}^{2}}$ |
| Magnetic component | ${H}_{φ} = \frac{j [ I ] sin θ}{2 r} \frac{L}{λ}$ | ${H}_{θ} = \frac{[ I ] sin θ}{r} \frac{A}{{λ}^{2}}$ |

From the table, the presence of the operator j in the dipole expressions and its absence in the loop equations indicate that the fields of the electric dipole and of the loop are in time phase quadrature. This quadrature relationship is a fundamental difference between the fields of pure magnetic dipoles (circular loops) and electric dipoles (linear elements).

The analytical models for showing the fields of antennas that are larger than short dipoles are mathematically complex even when the antennas have a high degree of symmetry. Even more difficulty of analysis arises when antennas have irregular shapes and require operations over multiple bands or with high bandwidth.

In the mobile communications environment, antennas are frequently placed inside the case of the communication device in close proximity to conductive components. In such close proximity, the antenna near and intermediate fields become significant and cannot be neglected to determine far field radiation patterns. For these reasons, the analytical models for short dipoles do not adequately predict the behavior of antennas needed for new communication devices. Fundamentally new designs and design techniques are needed to address the new environment of personal or otherwise small communication devices.

Personal communication devices, when in use, are usually located close to an ear or other part of the human body. Accordingly, use of personal communication devices subjects the human body to radiation. The radiation absorption from a communication device is measured by the rate of energy absorbed per unit body mass and this measure is known as the specific absorption rate (SAR). Antennas for personal communication devices are designed to have low peak SAR values so as to avoid absorption of unacceptable levels of energy, and the resultant localized heating by the body.

For personal communication devices, the human body is located in the near-field of an antenna where much of the electromagnetic energy is reactive and electrostatic rather than radiated. Consequently, it is believed that the dominant cause of high SAR for personal communication devices is from reactance and electric field energy of the near field. Accordingly, the reactance and electrostatic fields of personal communication devices need to be controlled to minimize SAR. Regardless of the reasons, low SAR is a desirable parameter along with the other important parameters for antennas in communication devices.

In consideration of the above background, there is a need for improved antennas suitable for communication devices and other devices needing small and compact antennas.

### SUMMARY

The present invention is a multiband antenna formed of superimposed compressed loops for use with a wireless communication device which operates for exchanging energy in bands of radiation frequencies. The compressed antenna includes connection means for conduction of electrical current through two or more superimposed compressed loops. Each compressed loop includes a plurality of electrically conducting segments, each segment having a segment length, where the segments are electrically connected in series to the connection means to form a loop antenna for exchange of energy in one of the bands of radiation frequencies. The segments for each of the loops are arrayed in a compressed pattern and the loops are superimposed whereby an area enclosed by one of the compressed loops covers an area enclosed by another of the compressed loops.

For each compressed loop, the segments are arrayed in multiple diverse directions. The pattern formed by the antenna segments may be regular and repeating or may be irregular and non-repeating. Collectively the arrayed segments appreciable increase antenna electrical lengths while permitting the antenna to be compressed to fit within the available areas of communication devices.

The multiple compressed loops provide multiple frequency bands of operation for the antenna. The multiple loops are arrayed in different configurations that include nested and and non-nested loops as well as closely located and spatially separated loops. The loops are constructed from multilayer materials that include a non-conductive substrate and one or more conducting layers.

Although the antenna's electrical length is not small compared to λ, the near field portions of the reactive field and the electrical field tend to be low whereby the SAR values for the compressed loop antenna tend to be low.

The multiple loops are connected in common to the connection element, either directly by electrical connection and/or by capacitive coupling.

The arrayed-segment loop antennas are typically located internal to the housings of personal communicating devices where they tend to be susceptible to de-tuning due to objects in the near field in close proximity to the personal communicating devices. The multi-loop antenna with multiple layers providing mirroring and reference planes tends to increase the immunity to de-tuning.

The foregoing and other objects, features and advantages of the invention will be apparent from the following detailed description in conjunction with the drawings.

### BRIEF DESCRIPTION OF THE DRAWINGS

FIG. 1 depicts a wireless communication device having a compressed antenna.

FIG. 2 depicts a schematic, cross-sectional end view of the FIG. 1 communication device.

FIG. 3 depicts a perspective view of a multi-loop compressed antenna used in the communication device of FIG. 1 and FIG. 2.

FIG. 4 depicts a cross-sectional view of one element of the multi-loop compressed antenna of FIG. 3.

FIG. 5 depicts components of the communication device of FIG. 1 including a connection element connecting an antenna and a transceiver unit.

FIG. 6 depicts a short electric dipole element antenna.

FIG. 7 depicts a three-dimensional representation of the fields of the short electric dipole element of FIG. 6.

FIG. 8 depicts a short loop element.

FIG. 9 depicts a three-dimensional representation of the fields of the short loop element of FIG. 8.

FIG. 10 depicts a three-dimensional representation of the E_{θ} and H_{φ} fields of the short dipole element of FIG. 6 and the E_{φ} and H_{θ} fields of the short loop element of FIG. 8.

FIG. 11 depicts a two-dimensional representation of the E_{θ} and H_{φ} fields of the short dipole element of FIG. 6 and the E_{φ} and H_{θ} fields of the short loop element of FIG. 8.

FIG. 12 depicts a top view of a four-loop, 6-legged compressed antenna, in a snowflake pattern, for use in a communication device.

FIG. 13 depicts a top view of the two-loop, 6-legged compressed antenna similar to the antenna of FIG. 12 together with an additional irregular compressed loop for use in a communication device.

FIG. 14 depicts a top view of a two-loop, 2-legged compressed antenna for use in a communication device.

FIG. 15 depicts a top view of a one-loop, 3-legged compressed antenna for use together with other loops in a communication device.

FIG. 16 depicts a top view of a one-loop, 4-legged compressed antenna for use together with other loops in a communication device.

FIG. 17 depicts a top view of a one-loop, 5-legged compressed antenna for use together with other loops in a communication device.

FIG. 18 depicts a top view of a one-loop, 6-legged compressed antenna for use together with other loops in a communication device.

FIG. 19 depicts a top view of a two-loop, 6-legged compressed antenna, in a snowflake pattern like the antenna of FIG. 12, where each loop has a separate pad for separate electrical connection to the transceiver unit in the communication device of FIG. 1 and FIG. 2.

FIG. 20 depicts a top view of a two-loop, 6-legged compressed antenna where the two loops are connected by a transmission line to pads for electrical connection to the transceiver unit in the communication device of FIG. 1 and FIG. 2.

FIG. 21 depicts a perspective view of a one-loop, 6-legged compressed antenna mounted on a flexible dielectric substrate for use in a communication device.

FIG. 22 depicts a top view of an antenna structure including compressed loops situated above and below a substrate.

FIG. 23 depicts a front view of the FIG. 22 antenna including a two-layer antenna structure on opposite sides of a dielectric layer.

FIG. 24 depicts a top view of the top layer of a two-loop, 6-legged compressed antenna together with an irregular loop that forms part of the antenna structure of FIG. 22.

FIG. 25 depicts a top view of the bottom layer of the antenna structure of FIG. 22.

FIG. 26 depicts a top view of the top layer of a two-loop, 6-legged compressed antenna together with an irregular loop, like the antenna structure of FIG. 24, with inter-loop connectors.

FIG. 27 depicts a voltage standing wave ration (VSWR) representation of the antenna of FIG. 22 with a FIG. 24 top layer.

FIG. 28 depicts a voltage standing wave ration (VSWR) representation of the antenna of FIG. 22 with a FIG. 26 top layer.

FIG. 29 depicts a top view of the top layer of a one-loop, 6-legged compressed antenna together with an irregular loop antenna that forms part of a multilayer antenna structure.

FIG. 30 depicts a top view of the bottom layer of a one-loop, 6-legged compressed antenna together with an irregular conducting patch that forms part of a multilayer antenna structure with the layer of FIG. 29.

FIG. 31 depicts a top view of the top layer of a two-loop, 6-legged compressed antenna together with an irregular loop antenna that forms part of a multilayer antenna structure.

FIG. 32 depicts a top view of the bottom layer of a two-loop, 6-legged compressed antenna together with irregular conducting pad that forms with the layer of FIG. 31 a multilayer compressed antenna.

FIG. 33 depicts a front view of an antenna including a three-layer antenna structure on opposite sides of a two dielectric layers.

FIG. 34 depicts a perspective view the antenna of FIG. 33.

FIG. 35 depicts a top view of a top layer including a one-loop, 6-legged compressed antenna together with an irregular one-loop compressed antenna that forms part of a multiband, multilayer compressed antenna.

FIG. 36 depicts a top view of a bottom layer including a one-loop, 6-legged compressed antenna together with an irregular conducting pad that forms part of the multiband, multilayer compressed antenna with the antenna of FIG. 35.

FIG. 37 depicts a top view of the multiband, multilayer compressed antenna showing the layers of FIG. 35 and FIG. 36 superimposed as they would appear on the top and bottom of a dielectric substrate.

FIG. 38 depicts a top view of a top layer including a two-loop, 6-legged compressed antenna together with an irregular one-loop compressed antenna that forms part of a multiband, multilayer compressed antenna.

FIG. 39 depicts a top view of a bottom layer including a two-loop, 6-legged compressed antenna together with an irregular conducting pad that forms part of the multiband, multilayer compressed antenna with the antenna of FIG. 38.

FIG. 40 depicts a top view of the multiband, multilayer compressed antenna showing the layers of FIG. 38 and FIG. 39 superimposed as they would appear on the top and bottom of a dielectric substrate.

FIG. 41 depicts a top view of a top layer including a two-loop, 6-legged compressed antenna together with an irregular two-loop compressed antenna that forms part of a multiband, multilayer compressed antenna.

FIG. 42 depicts a top view of a bottom layer including a two-loop, 6-legged compressed antenna together with an irregular conducting pad that forms part of the multiband, multilayer compressed antenna with the antenna of FIG. 41.

FIG. 43 depicts a top view of the multiband, multilayer compressed antenna showing the layers of FIG. 41 and FIG. 42 superimposed as they would appear on the top and bottom of a dielectric substrate.

FIG. 44 depicts a top view of a top layer including a one-loop, 6-legged compressed antenna together with an irregular one-loop compressed antenna that forms part of a multiband, multilayer compressed antenna.

FIG. 45 depicts a top view of a bottom layer including a one-loop, 6-legged compressed antenna together with an irregular conducting pad that forms part of the multiband, multilayer compressed antenna with the antenna of FIG. 35.

FIG. 46 depicts a top view of the multiband, multilayer compressed antenna showing the layers of FIG. 44 and FIG. 45 superimposed as they would appear on the top and bottom of a dielectric substrate.

FIG. 47 depicts a top view of a top layer including a one-loop, 6-legged compressed antenna together with an irregular one-loop compressed antenna that forms part of a multiband, multilayer compressed antenna.

FIG. 48 depicts a top view of a bottom layer including a one-loop, 6-legged compressed antenna together with an irregular conducting pad that forms part of the multiband, multilayer compressed antenna with the antenna of FIG. 35.

FIG. 49 depicts a top view of the multiband, multilayer compressed antenna showing the layers of FIG. 47 and FIG. 48 superimposed as they would appear on the top and bottom of a dielectric substrate.

FIG. 50 depicts a two-dimensional representation of the field pattern of the antenna structure of FIG. 40 for the GSM 900 MHz and GSM 1800 MHz bands.

FIG. 51 depicts a two-dimensional representation of the field pattern of the antenna structure of FIG. 40 for the GSM 900 MHz, GSM 1800 MHz and PCS 1900 MHz bands.

FIG. 52 depicts a voltage standing wave ration (VSWR) representation of the antenna of FIG. 40.

FIG. 53 depicts a top view of an outer irregular compressed loop with an inner two-loop, 6-legged compressed antenna, similar to the antenna of FIG. 12, together with a separate inner one-loop, 5-legged compressed antenna, similar to the antenna of FIG. 17, for use in a communication device.

FIG. 54 depicts a top view of an antenna structure including compressed loops above and below a substrate and is a variant of the FIG. 22 antenna.

FIG. 55 depicts a top view of the top layer having a compressed irregular loop that forms part of the antenna structure of FIG. 54.

FIG. 56 depicts a top view of the bottom layer of the antenna structure of FIG. 54.

FIG. 57 depicts a top view of an outer irregular compressed loop with an inner two-loop, 6-legged compressed antenna where the inner loop is relatively narrow.

FIG. 58 depicts a top view of an outer irregular compressed loop with an inner two-loop, 6-legged compressed antenna where the inner loop is relatively wide.

FIG. 59 depicts a top view of the bottom layer of the antenna structure, similar to the bottom layer of FIG. 56, where the inner loop of the two-loop compressed antenna is closed and floating.

FIG. 60 depicts a top view of the bottom layer of the antenna structure, similar to the bottom layer of FIG. 56, where the inner loop of the two-loop compressed antenna is formed of six legs where each of the legs is closed and floating.

FIG. 61 depicts a top view of the top layer, similar to the top layer of FIG. 55, additionally having an internal tuning stub.

FIG. 62 depicts a top view of the top layer, similar to the top layer of FIG. 55, additionally having an external tuning stub.

FIG. 63 depicts a top view of a one-loop, 6-legged compressed antenna where different segments have different thicknesses and shapes.

FIG. 64 depicts a top view of a two-loop, 6-legged compressed antenna where the two loops are on different layers and are connected in series using through-layer vias to form a two-turn compressed loop antenna.

FIG. 65 depicts a top view of a multilayer compressed loop antenna where the top two layers are similar to the antenna of FIG. 63.

### DETAILED DESCRIPTION

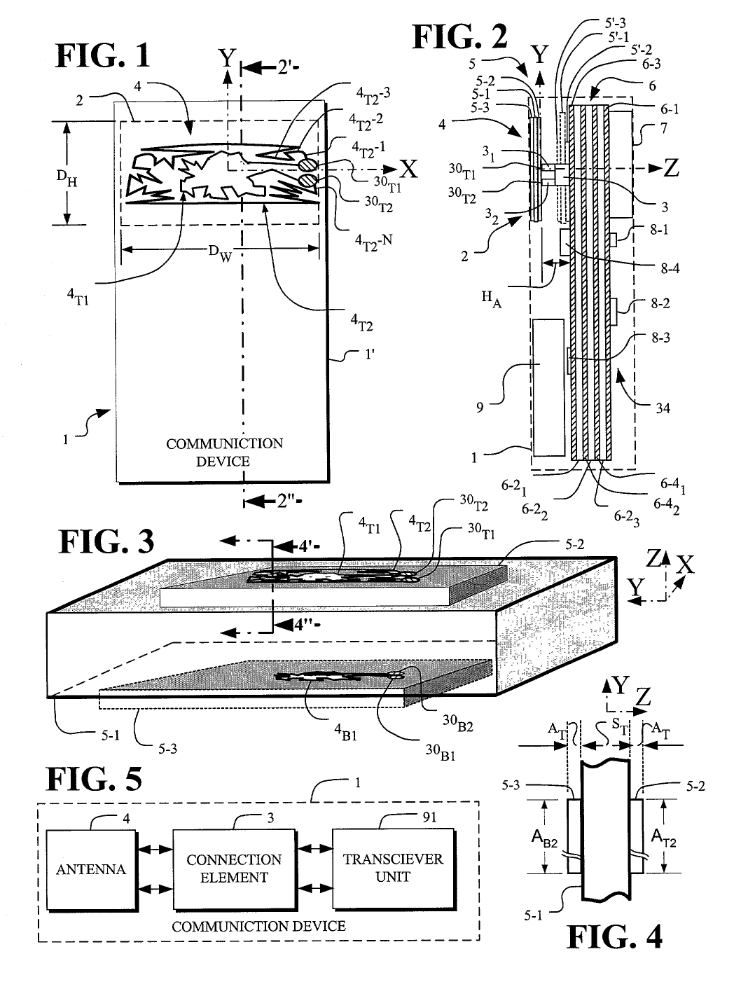

In FIG. 1, communication device 1 is a cell phone, pager or other similar communication device that can be used in close proximity to people. The communication device 1 includes an antenna area 2 allocated for an antenna 4 which receives and/or transmits radio wave radiation for the communication device 1. In FIG. 1, the antenna area 2 has a width D_{W} and a height D_{H}. A section line 2′-2″ extends from top to bottom of the communication device 1. Typically, the loop antenna 4 is affixed to the inside of the case 1′ of communication device 1 by a pressure sensitive adhesive, injection molding, insert molding or any other convenient manner of attachment. The case 1′ may be flat or curved so that antennas in some embodiments lie in one or more planes where those planes take the shape of the case 1′ which can be flat or curved.

In FIG. 1, the antenna 4 is a multi-loop antenna that includes a first compressed radiation loop 4_{T1} generally surrounded by a second compressed radiation loop 4_{T2}. The loops 4_{T1} and 4_{T2} are connected in common by connection pads 30_{T1} and 30_{T2}. The connection pads 30_{T1} and 30_{T2} are the termination points for antenna 4. Typically one of the termination points is the dive point and the other termination point is the common or ground point. The loops 4_{T1} and 4_{T2} generally lie in the XY-plane and have magnetic current in the Z-axis direction normal to the XY-plane.

In FIG. 1, antenna 4_{T2} has a plurality of electrically conducting radiation segments 4_{T2}-1, 4_{T2}-2, 4_{T2}-3, . . . , 4_{T2}-n, . . . , 4_{T2}-N each having a segment length. The segments 4_{T2}-1, 4_{T2}-2, 4_{T2}-3, . . . , 4_{T2}-n, . . . , 4_{T2}-N are connected in series to form a loop electrically connected between the first and second conductor pads 30_{T1} and 30_{T2}. The loop 4_{T2} has an electrical length, A_{l,T2}, that is proportional to the sum of segment lengths for each of the radiation segments 4_{T2}-1, 4_{T2}-2, 4_{T2}-3, . . . , 4_{T2}-n, . . . , 4_{T2}-N so as to facilitate an exchange of energy at radiation frequencies for antenna 4_{T2}. Similarly, the loop 4_{T1} has an electrical length, A_{l,T1}, that is proportional to the sum of segment lengths for each of the radiation segments so as to facilitate an exchange of energy at radiation frequencies for antenna 4_{T1}.

The term “segment” means any portion of a straight or curved line. Multiple segments are connected together end to end to form a loop. The interconnection of segments can appear discontinuous, for example where two straight-line segments form an angle less than 180 degrees, or can appear continuous, for example, where curved segments connect with a smooth continuous transition without a perceptible intersection. A continuous loop or continuous portions of a loop, where segment intersections are not apparent, can be arbitrarily partitioned into any number of short continuous segments with arbitrary locations of the intersections. The number of segments for a compressed loop is not particularly important. The important characteristic of a compressed loop is that the loop trace is one that has many turns that have the effect of lengthening the loop trace (electrical length of the loop) while reducing the enclosed area of the loop. A loop with such characteristics is defined to be a compressed loop having a compressed pattern. A compressed loop is compared with an equivalent circular loop formed with a circumference equal to the sum of all the lengths of the segments of the compressed loop. The enclosed area of the compressed loop is substantially less than the enclosed area of the equivalent circular loop.

In FIG. 1, antenna 4 has each of the loops 4_{T1} and 4_{T2} formed of straight-line segments arrayed in irregular compressed patterns and connected electrically in series to form a loop antenna. The straight-line segments of the antenna 4_{T2}, for example, fit within the antenna area 2, which has been allocated for an antenna in the communication device 1 of FIG. 1. The antenna 4_{T2} has an actual enclosed area, Aₐᵣₑₐ, that can be represented by an imaginary circle of radius R₁ so that Aₐᵣₑₐ=π(R₁)² and the imaginary circle has a circumference of π(2R₁). The antenna 4_{T2} has an electrical length, A_{l,T2} which if stretched into a circle would have a circumference of π(2R₂) where π(2R₂) is significantly longer than the circumference π(2R₁) of the imaginary circle representing the area enclosed by antenna 4_{T2}.

In FIG. 1, antenna 4 has each of the loops 4_{T1} and 4_{T2} formed of straight-line segments arrayed in multiple divergent directions not parallel to the XY orthogonal coordinate system so as to provide a long antenna electrical length while permitting the overall outside dimensions of the loops to fit within the antenna area 2 of the communication device 1.

The FIG. 1 antenna 4, including antenna elements 4_{T1} and 4_{T2}, is used for communication in frequency bands having, within the bands, nominal frequencies f₁ and f₂ with wavelengths, λ_{T1} and λ_{T2}, for one or more of the respective resonant frequencies of interest. In general, the frequencies f₁ and f₂ are not harmonically related. The wavelengths, λ_{T1} and λ_{T2}, are such that, for efficient antenna design, the electrical lengths, A_{lT1} and A_{lT2}, cannot be made small with respect to λ_{T1} and λ_{T2}. For this reason, it cannot be assumed that the simple analytical models used to describe loop antennas and electric dipole antennas apply without limitation. Rather, the analytical models are mathematically complex and not easily describable.

In FIG. 2, the communication device 1 of FIG. 1 is shown in a schematic, cross-sectional, end view taken along the section line 2′-2″ of FIG. 1. In FIG. 2, a circuit board 6 includes, by way of example, an outer conducting layer 6-1, internal insulating layers 6-2₁, 6-2₂, 6-2₃, internal conducting layers 6-4₁ and 6-4₂ and another outer conducting layer 6-3. Typically, the layer 6-4₁ is a ground plane and the layer 6-4₂ is a power supply plane. The printed circuit board 6 supports the electronic components associated with the communication device 1 including a display 7 and miscellaneous components 8-1, 8-2, 8-3 and 8-4 which are shown as typical. Communication device 1 also includes a battery 9. The antenna assembly 5 includes a substrate 5-1 and a conductive layer 5-2 that forms a loop antenna 4 offset from the printed circuit board 6 by a gap which tends to reduce coupling between the antenna 5-2 and the printed circuit board 6. In one embodiment, the offset of the antenna, H_{A}, above the board 6 is 6.92 mm and the offset of the antenna from the top of a can component mounted on board 6, such as component 8-4, is 4.83 mm. Typical offsets of the antenna 4 from the circuit board 6 are less than 10 mm and desirably less than approximately 5 mm. The ability of the compressed antenna to operate well with little or no offset (less than 20 mm) from the circuit board 6 is a feature of the compressed antennas that make them attractive for use in hand-held and other small communication devices.

The assembly 5 is typically constructed using well-known printed circuit materials and processes. For example, the materials include flexible laminates, polyimide flexible laminates, polyimide ridgidized substrates, polyester flexible substrates, polyester ridgidized substrates and plastics, glasses, woven glass laminates such as FR4, other laminates and other dielectrics in general. For example, the processes include printing or silk-screening of a metal onto a dielectric substrate, silk-screening onto the case of a mobile telephone or other commination device, metal deposition onto a dielectric substrate, stamping from a metal sheet, injection molding into the plastic of a mobile telephone case or other communication device, and insert molding into the plastic of a mobile telephone case or other communication device, and other layer and sheet formations of all types.

In one embodiment, the conductive layer 5-2 is connected to printed circuit board 6 by a connection element 3. In the embodiment shown in FIG. 1 and FIG. 2, the connection element 3 includes, for example, two tangs 3₁ and 3₂ that are spring-loaded against the two connection pads 30_{T1} and 30_{T2}, respectively. The two tangs have substantially the same spring compression for making balanced electrical connections to the two pads 30_{T1} and 30_{T2} these connections together with the pads function as first and second conductors for conducting electrical current through the antenna to operate the antenna as a loop antenna. While two tangs are typically employed, any number of one or more tangs are used depending on the number of connections required.

In an alternative embodiment, the compressed antenna 5 has layer 5′-2 situated closer to or directly on the printed circuit board 6 and substrate 5′-1 and layer 5′-3 are in close proximity to the printed circuit board 6.

The antenna 4 of FIG. 1 and FIG. 2, as described in many different embodiments hereinafter, is a compressed antenna that has small area so as to fit within the antenna area 2 of communication device 1. The antenna 4 operates with loop antenna properties, has low SAR and exhibits good performance in transmitting and receiving signals.

FIG. 3 depicts a perspective view of multi-loop antenna 4 in the communication device of FIG. 1 and FIG. 2. In FIG. 3, the multi-loop antenna 4 of FIG. 1 includes, in addition to the first compressed loop 4_{T1} and the second compressed loop 4_{T2}, a third compressed loop 4_{B1}. The third compressed loop 4_{B1} appears on layer 5-3 on the opposite side of substrate layer 5-1 as layer 5-2. The third compressed loop 4_{B1} connects at each end to connection pads 30_{B1} and 30_{B2}. For purposes of the FIG. 3 embodiment, the third compressed loop 4_{B1} is substantially the same size and shape as the first compressed loop 4_{T1} and is juxtaposed to the first compressed loop 4_{T1} as offset in the Z-axis direction. The loops 4_{T1}, 4_{T2} and 4_{B1}, therefore, all generally lie in or parallel to the XY-plane and have magnetic current in the Z-axis direction normal to the XY-plane. The relative locations of juxtaposed loops, such as loops 4_{T1}, 4_{T2} and 4_{B1} in FIG. 3 (or loops in any of the other embodiments hereafter described) are used as tuning parameters in the design and manufacture of loop antennas.

In FIG. 3, the third compressed loop 4_{B1} connects at connection pads 30_{B1} and 30_{B2} on layer 5-3 which are offset from the pads 30_{T1} and 30_{T2} on layer 5-2. In the embodiment of FIG. 3, connection pads 30_{B1} and 30_{B2} capacitively couple the pads 30_{T1} and 30_{T2} whereby the compressed loops 4_{T1}, 4_{T2} and 4_{B1} all are connected in common and are connected through the connection element 3 to the transceiver on circuit board 6 of FIG. 2. In alternative embodiments, through-layer conductors (vias) or other equivalent means are employed to interconnect the compressed loops 4_{T1}, 4_{T2} and 4_{B1}. In still other alternative embodiments, any two or more of the compressed loops 4_{T1}, 4_{T2} and 4_{B1} can connect independently through one or more connection elements to the transceiver on circuit board 6 of FIG. 2. In further embodiments, the compressed loops of a multi-loop antenna, with any number of loops such as two, three four or more, are located on the same circuit board 6 or multiple ones of other boards like board 5. The compressed loops of antennas are arrayed in various embodiments to have polarization diversity, time diversity and frequency diversity.

The connection pads 30_{B1} and 30_{B2} capacitively couple the pads 30_{T1} and 30_{T2} and in so doing remove the need in some multilayer embodiments for vias (internal through layer connections). The value of the capacitance between layers is determined in conventional manner. The structure is that of parallel plane conductors separated by a dielectric where the capacitance is a function of the thickness of the separating dielectric, the dielectric constant of the substrate, the type of material, the shape and the dimensions of the pads. The capacitance is selected to provide good coupling at the frequencies of interest. The pads are easily changed in position and shape to achieve the desired coupling. In some embodiments, the capacitance between pads is used as a circuit element which establishes, for example, a pass band filter between loops of a multi-loop antenna.

In FIG. 4, a schematic sectional view along the section line 4′-4″ of FIG. 4 is shown. In the example of FIG. 4, the thickness, S_{T}, of the dielectric substrate 5-1 is approximately 0.08 mm. The width, A_{T2}, of a segment 4_{T2}-n of antenna loop 4_{T2} in layer 5-2 is approximately 1.8 mm and the thickness, A_{T}, of the segment 4_{T1}-n is approximately 1.8 mm. The width of a segment of antenna loop 4_{T1} in layer 5-2 is approximately 1.8 mm and the thickness, A_{T}, of the segment is approximately 0.02 mm. The antenna material of FIG. 4 in one embodiment is Kapton Polyimide with a copper thickness 1 oz. double size on a 3 mil (0.076 mm) flexible laminate. In another embodiment, the material is a 1 oz. double sided 2 mil (0.051 mm) flexible laminate. In other embodiments, these elements can have any desired dimensions.

FIG. 5 depicts the major components that form the communication device 1 of FIG. 1. In particular, the transceiver unit 91 is formed by one or more of the components 8 mounted on the circuit board 6 of FIG. 2. The connection element 3 connects the transceiver unit 91 to the antenna 4.

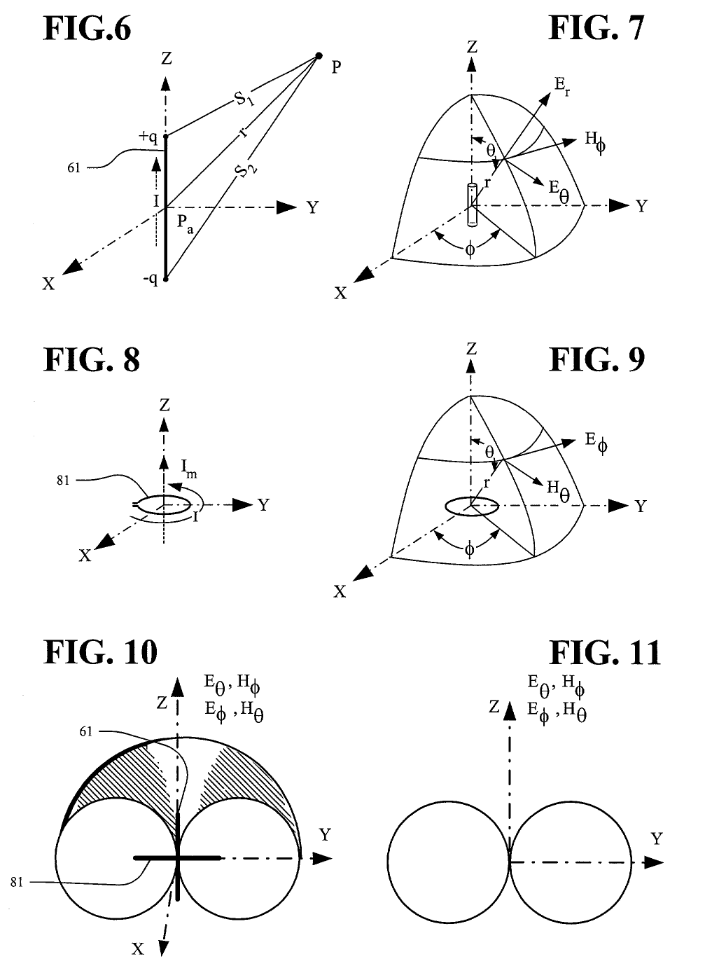

FIG. 6 depicts a short dipole element 61 along the Z axis normal to the XY-plane of antenna 4. The short dipole element is useful in explaining properties of antennas.

FIG. 7 depicts a three-dimensional representation of the fields of the short dipole element of FIG. 6. As discussed above, the equations of electric and magnetic components of the electric dipole at the far field are given as:

$${E}_{r} = 0$$

$${E}_{θ} = \frac{j60 π [ I ] sin θ}{r} \frac{L}{λ}$$

$${H}_{φ} = \frac{j [ I ] sin θ}{2 r} \frac{L}{λ}$$

Examining the E_{θ} and H_{φ} components in the far field, it can be seen that E_{θ} and H_{φ} are in time phase (with respect to each other) in the far field, and that the field patterns of both are proportional to sin(θ) but independent of φ. The space patterns of those fields are a figure of revolution and doughnut-shaped in three dimensions (see FIG. 10) figure-8 shaped in two dimensions (see FIG. 11).

FIG. 8 depicts a short loop element 81 lying in the XY-plane. A magnetic dipole for the loop element 81 conducts an electric current I that causes a magnetic current (Iₘ) in the Z axis direction normal to the XY-plane of the magnetic dipole. The analysis of the far field pattern of a magnetic dipole of FIG. 8 is similar to the analysis of the far field pattern of the electric dipole of FIG. 6. The difference is that the electric current I is replaced by a magnetic current Iₘ and the electric field is replaced by a magnetic field.

FIG. 9 depicts a three-dimensional representation of the fields of the short loop element of FIG. 8. The fields of the short magnetic dipole are the same as the fields of a short electric dipole with the E and H fields and I and Iₘ currents interchanged as follows:

| Small Electric Dipole | Small Magnetic Dipole |
|---|---|
| ${E}_{θ} = \frac{j60 π [ I ] sin θ}{r} \frac{L}{λ}$ | ${H}_{θ} = \frac{j [ {I}_{m} ] sin θ}{240 πr} \frac{L}{λ}$ |
| ${H}_{φ} = \frac{j [ I ] sin θ}{2 r} \frac{L}{λ}$ | ${E}_{φ} = \frac{j [ {I}_{m} ] sin θ}{2 r} \frac{L}{λ}$ |

$where [ {I}_{m} ] = {I}_{mo} {ⅇ}^{j ω ( t - r / c )}$

Considering the equation of the far field pattern for the magnetic dipole, both H_{θ} and E_{φ} are proportional to sin(θ) but independent of φ. Consequently, the far field pattern of the H_{θ} and E_{φ} components of a magnetic dipole are doughnut-shaped in three dimensions (see FIG. 10) and figure-8 circular in cross section (see FIG. 11).

FIG. 10 depicts a three-dimensional representation of the E_{θ} and H_{φ} fields of the short dipole element of FIG. 6 and the E_{φ} and H_{θ} fields of the short loop element of FIG. 8.

FIG. 11 depicts a two-dimensional representation of the E_{θ} and H_{φ} fields of the short dipole element of FIG. 6 and the E_{φ} and H_{θ} fields of the short loop element of FIG. 8.

In FIG. 6 through FIG. 11, properties of small elements were described to depict the nature of electric dipole operation and magnetic loop operation. Antennas that have properties that like those of the small magnetic loop of FIG. 8 are classified as “loop” antennas or as having loop antenna characteristics. While an extension of the mathematical derivation described in connection with FIG. 6 through FIG. 11 to the more complex compressed loops and antennas of the present application is not easily done, the actual performance of those compressed loops and antennas demonstrate loop antenna characteristics including good radiation properties and low SAR values.

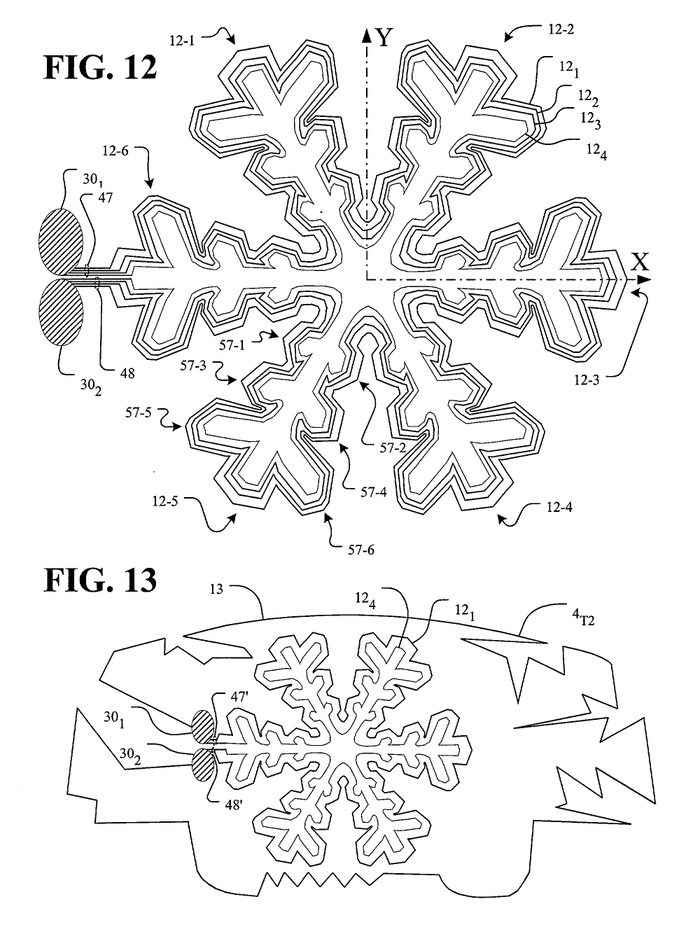

FIG. 12 depicts a top view of a four-loop, 6-legged compressed antenna, generally in a snowflake pattern, for use in a wireless communication device such as the device of FIG. 1 and FIG. 2. The compressed antenna of FIG. 12 is in a snowflake pattern in that each of the legs, specifically the six legs 12-1,12-2,12-3, 12-4, 12-5 and 12-6, for each of the four compressed loops 12₁, 12₂,12₃ and 12₄ are symmetrically disposed with each leg having multiple segments that are not arrayed parallel or normal to any XY orthogonal coordinate system. The multiple segments in each leg are further arrayed in sublegs described, for example, for leg 12-5 as typical. Particularly, leg 12-5 has six sublegs 57-1, 57-2, 57-3, 57-4, 57-5 and 57-6 symmetrically arrayed along the axis of leg 12-5. While six sublegs have been shown, any number of sublegs can be used. Typically, from one to six sublegs are selected. Three sublegs can be achieved, for example by eliminating sublegs 57-1, 57-4 and 57-5 on leg 12-5 and directly connecting sublegs 57-2 and 57-6.

In FIG. 12, the compressed loops 12₁, 12₂,12₃ and 12₄ each connect in common at one end to the pad 30₁ via conductors 47 and each connect in common at the other end to the pad 30₂ via conductors 48. The compressed loops 12₁, 12₂,12₃ and 12₄ are typically nested on the same layer supported by a dielectric substrate (not shown in FIG. 12) whereby an area enclosed by one of loops (for example, loop 12₂) is within an area enclosed by another of the loops (for example, loop 12₁). When compressed loops 12₁, 12₂,12₃ and 12₄ are nested on the same layer, the area enclosed by each of the more outer ones of the loops encloses the area enclosed by the more inner ones of the loops. Specifically, the area enclosed by loop 12₁ totally encloses the areas enclosed by the loops 12₂,12₃ and 12₄. Similarly, the area enclosed by loop 12₂ totally encloses the areas enclosed by the loops 12₃ and 12₄. Still similarly, the area enclosed by loop 12₃ totally encloses the area enclosed by the loop 12₄.

Although FIG. 12 contemplates that the compressed loops 12₁, 12₂,12₃ and 12₄ are on the same layer, typically supported by a dielectric substrate (not shown in FIG. 12), the compressed loops 12₁, 12₂,12₃ and 12₄ can be on one or more different layers supported by one or more dielectric layers. When arrayed on different layers, the compressed loops 12₁, 12₂,12₃ and 12₄ need not be nested, that is, the compressed loops are arrayed such that only a portion of the area enclosed by one compressed loop on one layer is superimposed over only a portion of the area enclosed by another one of the compressed loops on another layer.

For typical operation of the antenna of FIG. 12 in a communication device, the pad 30₁ connects to the driving source and is called the drive point while the pad 30₂ is connected to the common or ground point.

FIG. 13 depicts a top view of a two-loop, 6-legged compressed antenna similar to FIG. 12 together with an additional irregular compressed loop 13 for use in a wireless communication device such as the device 1 of FIG. 1 and FIG. 2. The compressed antenna of FIG. 13 has the snowflake pattern where compressed loops 12₁ and 12₄, each formed of six legs, are surrounded by an additional irregular compressed loop 13. The compressed loops 12₁ and 12₄ and the irregular compressed loop 13 all connect at one end to the pad 30₁ and all connect at the other end to the pad 30₂. When the compressed loops 12₁, 12₄ and 13 are nested on the same layer, the area enclosed by each of the more outer ones of the loops encloses the area enclosed by the more inner ones of the loops. When arrayed on different layers, the compressed loops 12₁, 12₄ and 13 need not be nested, that is, the compressed loops are arrayed such that only a portion of the area enclosed by one compressed loop on one layer is superimposed over a portion of the area enclosed by another one of the compressed loops on another layer. The compressed loops 12₁ and 12₄ each connect at one end to the pad 30₁ via conductors 47′ and each connect at the other end to the pad 30₂ via conductors 48′. Similarly, the conductors at each end of the antenna 13 connects to one of the pads 30₁ and 30₂.

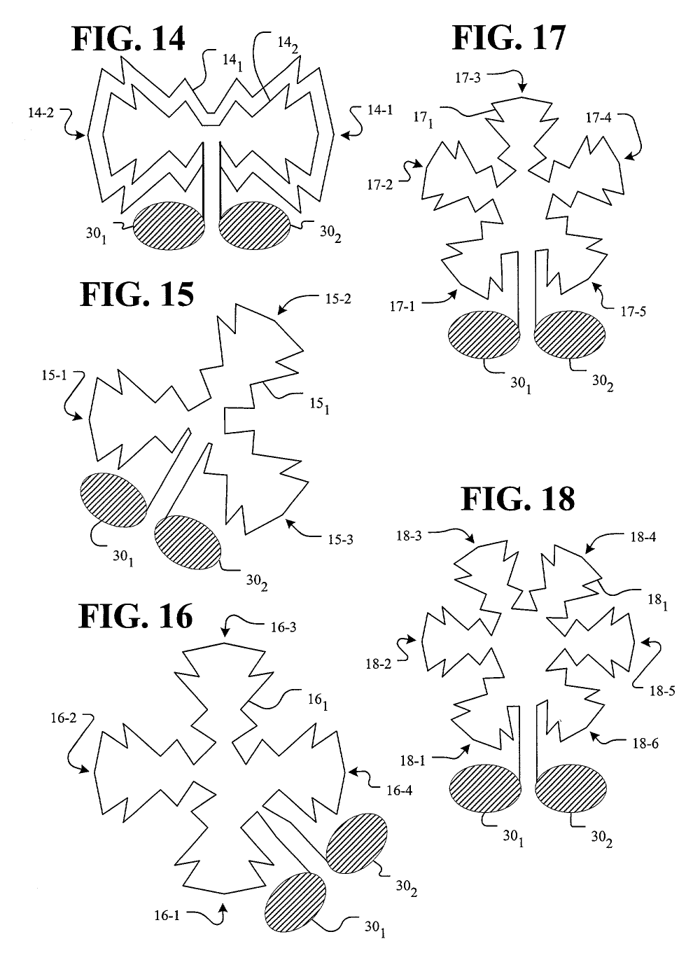

FIG. 14 depicts a top view of a two-loop, two-legged compressed antenna for use in a communication device such as communication device 1 of FIG. 1 and FIG. 2. The compressed antenna of FIG. 14 includes two compressed loops 14₁ and 14₂ each formed into two legs 14-1 and 14-2. The compressed loops 14₁ and 14₂ when on a single layer are nested together and connect at one end to the pad 30₁ and connect at the other end to the pad 30₂. When arrayed on different layers, the compressed loops 14₁ and 14₂ need not be nested, that is, the compressed loops can be arrayed such that only a portion of the area enclosed by one compressed loop on one layer is superimposed over a portion of the area enclosed by the other one of the compressed loops on another layer. While only two loops are shown for the 2-legged compressed loop antenna of FIG. 14, any number of one or more compressed loops may be used to form the 2-legged compressed antenna.

FIG. 15 depicts a top view of a one-loop, 3-legged compressed antenna for use together with other loops in a communication device such as communication device 1 of FIG. 1 and FIG. 2. The compressed antenna of FIG. 15 includes one compressed loop 15₁ formed into three legs 15-1, 15-2 and 15-3. The compressed loop 15₁ connects at one end to the pad 30₁ and connects at the other end to the pad 30₂. While only one loop 15₁ is shown for the 3-legged compressed loop antenna of FIG. 15, any number of one or more compressed loops may be used to form the 3-legged compressed antenna. When more than one 3-legged compressed antenna is arrayed on the same layer, the compressed loops are nested and when arrayed on different layers, the compressed loops need not be nested.

FIG. 16 depicts a top view of a one-loop, 4-legged compressed antenna for use together with other loops in the communication device such as communication device 1 of FIG. 1 and FIG. 2. The compressed antenna of FIG. 16 includes one compressed loop 16₁ formed into four legs 16-1, 16-2, 16-3 and 16-4. The compressed loop 16₁ connects at one end to the pad and connects at the other end to the pad 30₂. While only one loop 16₁ is shown for the 4-legged compressed loop antenna of FIG. 16, any number of one or more compressed loops may be used to form the 4-legged compressed antenna. When more than one 4-legged compressed antenna is arrayed on the same layer, the compressed loops are nested and when arrayed on different layers, the compressed loops need not be nested.

FIG. 17 depicts a top view of a one-loop, 5-legged compressed antenna for use together with other loops in the communication device such as communication device 1 of FIG. 1 and FIG. 2. The compressed antenna of FIG. 17 includes one compressed loop 17₁ formed into five legs 17-1, 17-2,17-3,17-4 and 17-5. The compressed loop 17₁ connects at one end to the pad and connects at the other end to the pad 30₂. While only one loop 17₁ is shown for the 5-legged compressed loop antenna of FIG. 17, any number of one or more compressed loops may be used to form the 5-legged compressed antenna. When more than one 5-legged compressed antenna is arrayed on the same layer, the compressed loops are nested and when arrayed on different layers, the compressed loops need not be nested.

FIG. 18 depicts a top view of a one-loop, six-legged compressed antenna for use together with other loops in the communication device such as communication device 1 of FIG. 1 and FIG. 2. The one-loop, 6-legged compressed antenna of FIG. 18 is in a snowflake pattern including one compressed loop 18₁ formed into six legs 18-1, 18-2,18-3, 18-4, 18-5 and 18-6. The compressed loop 18₁ connects at one end to the pad 30₁ and connects at the other end to the pad 30₂. When more than one 6-legged compressed antenna is arrayed on the same layer, the compressed loops are nested and when arrayed on different layers, the compressed loops need not be nested.

All of FIG. 14 through FIG. 18 depict antennas with legs are that are arrayed with a periodically repeating pattern. In FIG. 14, the pattern is repeated twice. In FIG. 15, FIG. 16, FIG. 17 and FIG. 18 the patterns are repeated three, four, five and six times, respectively.

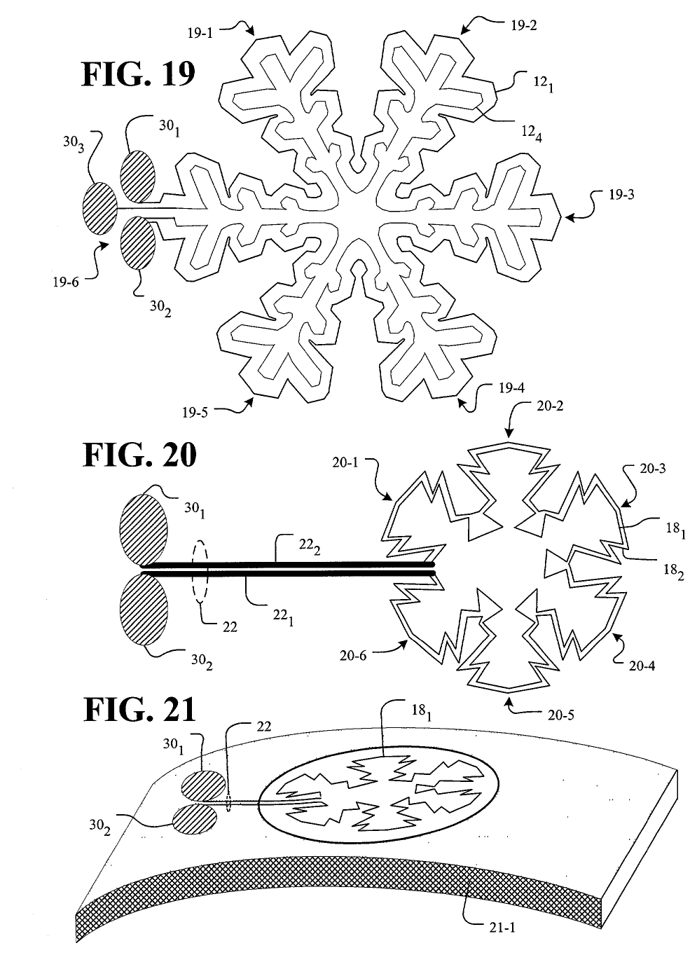

FIG. 19 depicts a top view of a two-loop, 6-legged compressed antenna, in a snowflake pattern, where each loop has a separate pad for separate electrical connection to the transceiver unit in the communication device such as communication device 1 of FIG. 1 and FIG. 2. The compressed antenna of FIG. 19 is in a snowflake pattern including the two compressed loops 12₁ and 12₄ formed into six legs 19-1, 19-2, 19-3, 19-4, 19-5 and 19-6. The compressed loop 12₁ connects at one end to the pad 30₁ and connects at the other end to the pad 30₂. The compressed loop 12₄ connects at one end to the pad 30₃ and connects at the other end to the pad 30₂. While two compressed loops 12₁ and 12₄ are shown for the 6-legged compressed loop antenna of FIG. 19, any number of one or more compressed loops may be used to form the 6-legged compressed antenna. Each one or more of the 6-legged compressed antennas may include a separate pad for separate electrical connection. For typical operation, the pads 30₁ and 30₃ connect to the driving source and are called drive points while the pad 30₂ is connected to the common or ground point.

FIG. 20 depicts a top view of a two-loop, 6-legged compressed antenna where the two loops are connected by a transmission line 22 to the two compressed loops 18₁ and 18₂ for electrical connection to the transceiver unit in the communication device such as communication device 1 of FIG. 1 and FIG. 2. The two-loop, 6-legged compressed antenna of FIG. 20 includes the two compressed loops 18₁ and 18₂ formed into six legs 20-1, 20-2, 20-3, 20-4, 20-5 and 20-6. The two compressed loops 18₁ and 18₂ are connected by the conductors 21₁ and 21₂ of transmission line 22 to pad 30₁ and pad 30₂, respectively.

FIG. 21 depicts a perspective view of a one-loop, 6-legged compressed antenna of FIG. 20 mounted on a flexible dielectric substrate 21-1 for use in the communication device such as communication device 1 of FIG. 1 and FIG. 2. When the case 1′ of the communication device 1 of FIG. 1 is curved, the flexible dielectric substrate 21-1 bends to fit the curvature of the case 1′.

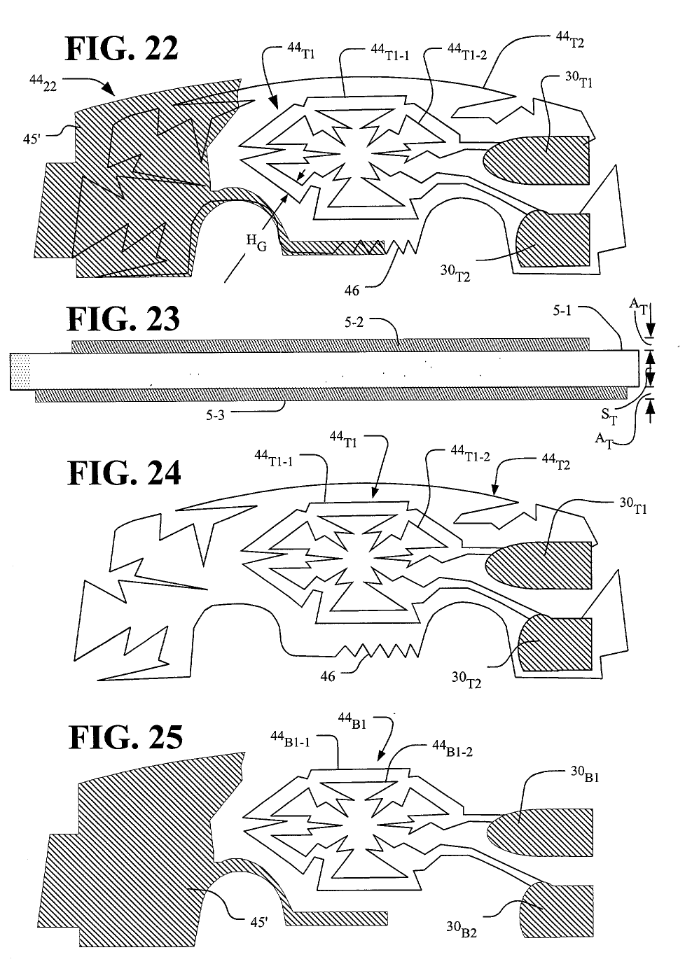

FIG. 22 depicts a top view of a multi-loop antenna 44 that includes a first compressed loop 44_{T1} generally surrounded by a second compressed loop 44_{T2}. The loops 44_{T1} and 44_{T2} are connected in common at each end by connection pads 30_{T1} and 30_{T2}. The loops 44_{T1} and 44_{T2} generally lie in the XY-plane and have magnetic current in the Z-axis direction normal to the XY-plane. The loop 44_{T1} is formed of two concentric loops, namely, sub-loops 44_{T1-1} and 44_{T1-2}, where sub-loop 44_{T1-2} is nested within sub-loop 44_{T1-1}. The antenna 44 of FIG. 22 in one embodiment measures approximately 38 mm by 15 mm.

To achieve the wide bandwidth for the GSM1800 and PCS1900 frequency bands, the loop 44_{T1} uses two sub-loops 44_{T1-1} and 44_{T1-2} with nominal resonant frequencies, having wavelengths, λ_{T1-1} and λ_{T1-2}, that are close to each other. In general, the frequencies of the GSM1800 and PCS1900 frequency bands are not harmonically related. In FIG. 22, the multi-loop antenna 44 includes a layer below the layer having the loop 44_{T1} and two sub-loops 44_{T1-1} and 44_{T1-2} that is over a lower layer compressed loop 44_{B1-1} surrounded by a second compressed loop 44_{B2-2} (see FIG. 25). The lower layer also includes a conducting patch 45′ (see FIG. 25). In the embodiment described, the electrical length of sub-loop 44_{T1-1} is approximately 55.1 mm and the sub-loop fits within a rectangle of approximate height 9.4 mm and width 19.5 mm and the electrical length of sub-loop 44_{T1-2} is approximately 99.9 mm and the sub-loop 44_{T1-2} fits within a rectangle of approximate height 7.4 mm and width 18 mm.

In FIG. 22, the multi-loop antenna 44₂₂ includes the compressed loop 44_{T2} which provides the GSM900 capabilities for antenna 44. The loop 44_{T2} is connected in common to the loop 44_{T1} at each end by connection pads 30_{T1} and 30_{T2}. The loops 44_{T1} and 44_{T2} generally lie in the XY-plane and have magnetic current in the Z-axis direction normal to the XY-plane. The average offset, H_{G}, of the loop 44_{T2} from the loop 44_{T1} has an effect on the radiation performance of the antenna. In FIG. 22 for PCS and DCS bands, a gap of 0.69 mm works well while a gap of 0.32 mm reduces the gain by 5-10 dB.

The size of the gap between the loops, described for example in connection with FIG. 22, is important in some embodiments for good performance. In the embodiment described, when the gap is decreased from a value above 0.69 mm to 0.69 mm, the bandwidth over which the VSWR is at a good low value increases and the increase is a substantial improvement when the loops are very close together. However, as the gap is decreased as described, the gain of the antenna undesirably decreases. With a decrease from 0.69 mm to 0.32 mm, the gain fell off by 5-10 dB even though the VSWR improved. When the gap is increased to more than 0.69 mm, the gain increases slightly, but the VSWR undesirably also increases as a single band begins to transform into two bands.

The “gap” between loops generally refers to an average gap, a nominal gap or an approximate gap since the shape of each loop may vary significantly and a point by point measurement of a gap may be impossible. Nonetheless, a gap as an offset between loops is readily determinable and changes in such gaps for tuning are readily determinable. Therefore, the gap is a tuning element and the magnitude of the gap is a tuning parameter proportional to the gap between loops.

A “tuned gap” between superimposed loops is a gap that balances between good gain and good VSWR. Due to the complexity of distributed capacitive and inductive properties of the superimposed loops, an empirical approach is used to establish a tuned gap. To find the tuned gap, the spacing between the loops is iteratively altered while maintaining the same general shape of the loops. The tuned gap is the gap where the VSWR performance and gain performance are maximized. An alternative approach for establishing a tuned gap utilizes a computational algorithm with empirical and historical data to approximate the inductances, capacitances and other parameters of the antennas. Due to the computational complexities, computational methods tend to have great inaccuracies that still require testing of antennas constructed based upon the computations.

In FIG. 22, the loop 44_{T2} includes the tuning element 46 formed of segments that meander in a short close pattern and that are connected in series with the loop 44_{T2}. The tuning parameter of the tuning element 46 is the length of the tuning element 46. The lengths of the segments or the number of the segments in the tuning element 46 are easily varied without changing the general shape of the overall array of segments (trace) that forms loop 44_{T2}. The tuning element 46 is used to “tune” the the loop 44_{T2} by adding or deleting length to loop 44_{T2} thereby tuning loop 44_{T2} and antenna 44. Other segments can be modified to add or delete length to loop 44_{T2} while at the same time changing the general shape of the overall array of segments (trace) that forms loop 44_{T2}. Variations in antenna size and other physical parameters can result when a design is ported from one communication device to another and hence tuning features of the antenna 44 are important in achieving the desired antenna performance over all bands of interest for each particular communication device.

The line length, and hence the inductance and resistance of the compressed loop 44_{T2} is increased when the length the tuning section 46 is increased. In the embodiment shown, the tuning section 46 is in a sawtooth pattern of segments inserted in series with the antenna trace of compressed loop 44_{T2}. Other embodiments of the tuning section 46 have any convenient shape including sinusoidal, rectangular wave and irregular elements or segments. An irregular tuning element is typically formed of non-repeating, short segments of varied orientations.

The tuning section 46 allows the compressed loop 44_{T2} to be decreased in size for the same electrical length so as to fit into a pre-defined space without substantially altering the overall shape and area of the compressed loop which define the reactive structure. In this manner, the tuning section 46 is utilized to tune the antenna 44 without substantially altering the defining radiative structures of the antenna 44. In addition to the segments 46, the size and location of the pads 30 and other antenna elements can be easily adjusted for tuning.

FIG. 23 depicts a front view of the antenna structure of FIG. 22. In FIG. 15, an antenna layer 5-2 is on top of the substrate 5-1 and an antenna 5-3 is below the substrate layer 5-1. The thickness, S_{T}, of the dielectric substrate 5-1 is approximately 0.08 mm the thickness, A_{T}, of the layers 5-2 and 5-3 are approximately 1.8 mm

FIG. 24 depicts a top view of the top layer 5-2 of the antenna structure of FIG. 22. The multi-loop antenna of FIG. 24 includes the first compressed loop 44_{T1} surrounded by a second compressed loop 44_{T2}. The loop 44_{T1} includes sub-loop 44_{T1-1} and sub-loop 44_{T1-2} that are spaced apart on an average by approximately 0.02 mm and are connected in common with the ends of loop 44_{T2} at each end by connection pads 30_{T1} and 30_{T2}. The loops 44_{T1} and 44_{T2} generally lie in the XY-plane and have magnetic current in the Z-axis direction normal to the XY-plane.

FIG. 25 depicts a top view of the bottom layer 5-3 of the antenna 44₂₂ of FIG. 22. The layer 5-3 portion of the multi-loop antenna of FIG. 25 includes the first compressed loop44_{B1-1} surrounding a second compressed loop 44_{B1-2}. The loops 44_{B1-1} and 44_{B1-2} on layer 5-3 are on the opposite side of substrate layer 5-1 as layer 5-2 and are juxtaposed and have the same size and shape as the loops 44_{T1-1} and 44_{T1-2} of layer 5-2 and hence loops 44_{B1-1} and 44_{B1-2} are “mirror images” of the loops 44_{T1-1} and 44_{T1-2}. The loops 44_{B1} and 44_{B2} connect at each end to connection pads 30_{B1} and 30_{B2}. The loops44_{T1},44_{T2} and 44_{B1} all generally lie in or parallel to the XY-plane and have magnetic current in the Z-axis direction normal to the XY-plane. The layer 5-3 also includes a conductive patch 45′ that serves as a ground or parasitic patch for the antenna 44₂₂. The patch 45′ functions to tune the antenna 44₂₂ and particularly loop 44_{T2}. Although it is often difficult to obtain low VSWR in an internal antenna environment, the patch 45′ is a parasitic element that is effective in tuning the overall impedance of antenna 44₂₂ to 50 ohms or some other desired impedance at the output.

In the embodiment of FIG. 22 through FIG. 25, connection pads 30_{B1} and 30_{B2} capacitively couple the pads 30_{T1} and 30_{T2} whereby the compressed loops 44_{T1}, 44_{T2} and 44_{B1} all are connected in common and are connected through the connection element 3 to the transceiver on circuit board 6 of FIG. 2. In alternative embodiments, through-layer conductors or other equivalent means are employed to interconnect the compressed loops 44_{T1}, 44_{T2} and 44_{B1}. In still other alternative embodiments, any two or more of the compressed loops 44_{T1}, 44_{T2} and 44_{B1} can connect independently through one ore more connection elements to the transceiver on circuit board 6 of FIG. 2. In other embodiments, the compressed loops of a multi-loop antenna, with any number of loops such as two, three four or more, are located on the same circuit board 6 or multiple ones of other boards like board 5 having single, double or more layers. For the particular embodiments disclosed, the antenna 44₂₂ is designed to perform better when the antenna has an offset, H_{A}, from the ground plane 6-4₂ and grounded components (such as 8-4) of the board 6 of FIG. 2.

The dimensions of the sub-loops 44_{T1-1} and 44_{T1-2} including line traces (see A_{T} and A_{B1} and A_{T1} in FIG. 4) and their overall lengths determine the desired resonant frequencies. The length expected for each loop does not agree with the length of a single loop determined for free space. It has been found that the line length that is effective in each loop does not necessarily agree with the line length described by classical loop antenna equations. In addition, the dimensions of the tangs and antenna together are combined to obtain resistance close to 50 ohms for good VSWR and strong radiation.

The connection element ensures good electrical (close to 50 ohms for all required bandwidth) and strong mechanical properties with the necessary height for connection to circuit board 6 in FIG. 2. Since current tends to be divided in each of the loops of antenna 44₂₂ in proportion to the loop impedance at that frequency (“Current Divider Rule”), the impedance in each loop is approximately the same at the connection point. Using common feeding points from the antenna for all the sub-loops simplifies the design and insures balanced connection over all the frequency ranges. The multi-loop antenna 44₂₂ has a gap between each sub-loop where the gap has been selected for good performance. A larger distance between the sub-loops may displace the resonant frequencies that are combined for obtaining wider bandwidth. A smaller distance between the sub-loops may result in a poorer radiation pattern.

In summary, the FIG. 22 through FIG. 25 embodiment of a multi-loop antenna provides a triband antenna with the following specifications.

Frequency Range

| | |
|---|---|
| GSM 800 MHz | 880-960 MHz |
| European PCS 1800 MHz | 1710-1880 MHz |
| US PCS 1900 MHz | 1850-1990 MHz |

VSWR

| | |
|---|---|
| GSM (Tx Bandwidth) | less than 3.0:1 |
| European PCS (Tx Bandwidth) | less than 2.5:1 |
| US PCS (Tx Bandwidth) | less than 2.5:1 |

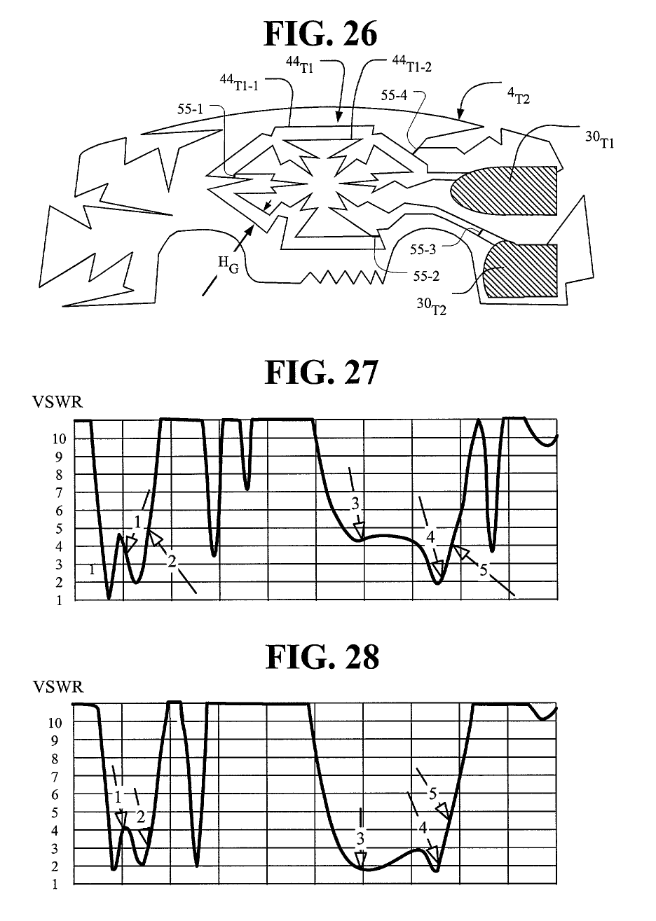

FIG. 26 depicts top view of an alternate antenna layer 5-2, similar to the layer of FIG. 24, of the antenna structure of FIG. 22. The multi-loop antenna of FIG. 26 includes the first compressed loop 44_{T1} surrounded by a second compressed loop 44_{T2}. The loop 44_{T1} includes sub-loop 44_{T1-1} and sub-loop 44_{T1-2} that are spaced apart on an average by approximately 0.02 mm and are connected in common with the ends of loop 44_{T2} at each end by connection pads 30_{T1} and 30_{T2}. The loops 44_{T1} and 44_{T2} generally lie in the XY-plane and have magnetic current in the Z-axis direction normal to the XY-plane. The antenna of FIG. 26 additionally includes loop interconnects 55-1, 55-2 and 55-3 interconnecting the sub-loop 44_{T1-1} and sub-loop 44_{T1-2}. The antenna of FIG. 26 additionally includes an alternate loop interconnect 55-4 interconnecting the sub-loop 44_{T1-2} and loop 44_{T2} that in some embodiments is not used and in other embodiments is used with the loop interconnects 55-1, 55-2 and 55-3.

FIG. 27 depicts a voltage standing wave ration (VSWR) representation of the antenna of FIG. 22 with FIG. 24 top layer not having any of the loop interconnects 55-1, 55-2, 55-3 or 55-4 of FIG. 26. The FIG. 22 antenna with the FIG. 24 top layer has VSWR as follows:

| ARROW | FREQUENCY | VSWR |
|---|---|---|
| 1 | 880 MHz | 3.75 |
| 2 | 980 MHz | 5.03 |
| 3 | 1.71 GHz | 4.35 |
| 4 | 1.99 GHz | 2.19 |
| 5 | 2.03 GHz | 3.90 |

FIG. 28 depicts a voltage standing wave ration (VSWR) representation of the antenna of FIG. 22 with the FIG. 26 top layer having only the loop interconnects 55-1, 55-2 and 55-3 and not the loop interconnects 55-4. The FIG. 22 antenna with the FIG. 26 top layer has VSWR as follows:

| ARROW | FREQUENCY | VSWR |
|---|---|---|
| 1 | 880 MHz | 4.44 |
| 2 | 980 MHz | 3.31 |
| 3 | 1.71 GHz | 1.05 |
| 4 | 1.99 GHz | 2.22 |
| 5 | 2.03 GHz | 4.51 |

A comparison of FIG. 28 with FIG. 27 demonstrates that the VSWR is improved when the loop interconnects 55-1, 55-2 and 55-3 interconnecting the sub-loop 44_{T1-1} and sub-loop 44_{T1-2} are employed. Further, in alternate embodiments, the antenna of FIG. 26 employs loop interconnects like loop interconnect 55-4 interconnecting the sub-loop 44_{T1-2} and loop 44_{T2}. In such alternate embodiments, the effect of the loop interconnect 55-4 is to significantly shift the frequency of the low band of frequencies. The loop interconnects 55 can be situated anywhere to tune the high band of the antenna.

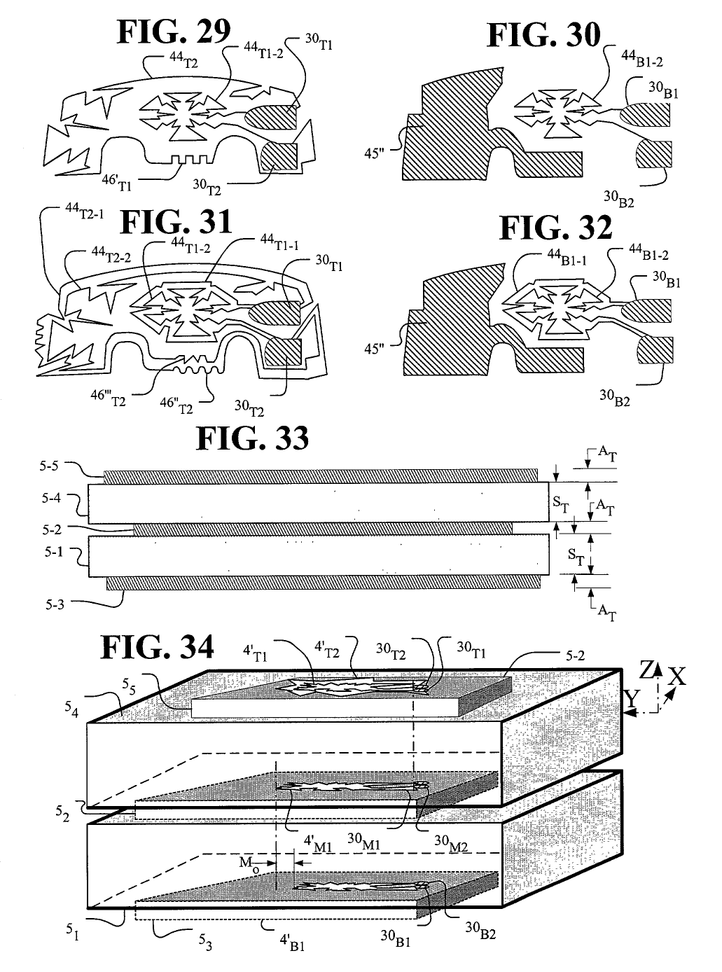

FIG. 29 depicts a top view of the top layer of a one-loop, 6-legged compressed antenna together with an irregular loop antenna that forms part of a multilayer antenna structure. The compressed antenna of FIG. 29 includes a one-loop, 6-legged compressed loop antenna 44_{T1-2} surrounded by an irregular loop antenna 44_{T2} that forms part of a multilayer antenna structure 44. The compressed loop 44_{T1-2} connects at one end to the pad 30_{T1} and connects at the other end to the pad 30_{T2}. The irregular loop 44_{T2} connects at one end to the pad 30_{T1}, and connects at the other end to the pad 30_{T2} and contains a tuning element 46′_{T1}, having a rectangular wave shape, that is modified in length during manufacture to tune adjust the frequency of the irregular loop antenna 44_{T2}.

FIG. 30 depicts a top view of the bottom layer including a one-loop, 6-legged compressed antenna together with irregular conducting region (patch) that forms part of a multilayer antenna structure with the layer of FIG. 29. The one-loop, 6-legged compressed antenna of FIG. 30 includes the one compressed loop 44_{B1-2} together with the irregular conducting patch 45″. The compressed loop 44_{B1-2} connects at one end to the pad 30_{B1} and connects at the other end to the pad 30_{B2}.

FIG. 31 depicts a top view of the top layer of a two-loop, 6-legged compressed antenna together with an irregular loop antenna that forms part of a multilayer antenna structure. The two-loop, 6-legged compressed antenna layer of FIG. 31 includes the two compressed loops 44_{T1-1} and 44_{T1-2} surrounded by two irregular loop antennas 44_{T2} and 44_{T1}. The compressed loops 44_{T1-1} and 44_{T1-2} connect at one end to the pad 30_{T1} and connect at the other end to the pad 30_{T2}. The irregular loops 44T₁ and 44_{T2} connect at one end to the pad 30_{T1} and connect at the other end to the pad 30_{T2} and contain variable adjustment segments 46′″_{T1} (having an irregular wave shape) and 46″_{T2} (having a sinusoidal wave shape), respectively.

FIG. 32 depicts a top view of the bottom layer of a two-loop, six-legged compressed antenna together with irregular conducting pad that forms with the layer of FIG. 31 a multilayer compressed antenna. The two-loop, 6-legged compressed antenna layer of FIG. 32 includes the two compressed loops 44_{B1-1} and 44_{B1-2} together with the conducting patch 45″. The compressed loops 44_{B1-1} and 44_{B1-2} connect at one end to the pad 30_{B1}, and connect at the other end to the pad 30_{B2}.

FIG. 33 depicts a front view of an antenna including a three-layer antenna structure on opposite sides of a two dielectric layers. The top layer is an antenna layer 5-5 with a thickness A_{T} located juxtaposed a dielectric layer 5-4 with a thickness S_{T} in turn juxtaposed an antenna layer 5-3 with a thickness A_{T}, in turn juxtapose a dielectric layer 5-2 with a thickness S_{T} juxtaposed an antenna layer 5-3 with a thickness A_{T}. The thicknesses, S_{T}, of the dielectric substrate 5-1 and 5-4 are typically approximately 0.08 mm. The thicknesses, A_{T}, are typically approximately 1.8 mm.

FIG. 34 depicts an isometric view of the antenna of FIG. 33. A multi-loop antenna 4′ includes a compressed loop antenna 4′_{T1} nested with a compressed loop antenna 4′_{T2} together superimposed with a compressed loop antenna 4′_{M1} and a compressed loop antenna 4′_{B1}. The compressed loop antenna 4′_{M1} is situated on layer 5-2 in between dielectric layers 5-1 and 5-4. The compressed loop antenna 4′_{M1} connects at each end to connection pads 30_{M1} and 30_{M2}. The compressed loop antenna 4′_{B1} is situated on layer 5-1 on the opposite side of substrate layer 5-3 as layer 5-2. The compressed loop antenna 4′_{B1} connects at each end to connection pads 30_{B1} and 30_{B2}. The compressed loop antenna 4′_{M1} and the compressed loop antenna 4′_{B1} in some embodiments are substantially the same size and shape as the compressed loop antenna 4′_{T1} and are juxtaposed the compressed loop antenna 4′_{T1} and are offset in the Z-axis direction. Th Z-axis dimensions are somewhat exaggerated in order to show more clearly the alignment of the compressed antennas. The loops 4′_{T1}, 4′_{T2}, 4′_{M1} and 4′_{B1} all generally lie in or parallel to the XY-plane and have magnetic current in the Z-axis direction normal to the XY-plane.

In the embodiment shown in FIG. 34, the compressed loop antenna 4′_{M1} is somewhat larger than the compressed loop antennas 4′_{T1} and 4′_{B1}. Accordingly, the compressed loop antenna 4′_{M1} has an offset Mₒ in the Y-axis direction so that the compressed antennas on different layers are not nested nor identically aligned. However, a substantial portion of the area enclosed by the compressed loop antenna 4′_{M1} covers the area enclosed by the compressed loop antennas 4′_{T1} and 4′_{B1}. Note, however, that the connection pads 30_{T1} and 30_{T2}, the connection pads 30_{M1} and 30_{M2} and the connection pads 30_{B1} and 30_{B2} remain aligned to facilitate capacitive coupling from layer to layer.

FIG. 35 depicts a top view of a top layer including a one-loop, 6-legged compressed antenna together with an irregular one-loop compressed antenna that forms part of a multiband, multilayer compressed antenna. The one-loop, 6-legged compressed antenna of FIG. 35 includes one compressed loop antenna 44_{T1} surrounded by an irregular loop antenna 44_{T2}. The compressed loop antenna 44_{T1} connects at one end to the pad 30_{T1} and connects at the other end to the pad 30_{T2}. The irregular loop antenna 44_{T2} connects at one end to the pad 30_{T1} and connects at the other end to the pad 30_{T2.}. Typically, the pad 30_{T1} is the “driving” pad for connection to the driving connection of the transceiver unit 91 and the pad 30_{T2.} is a “ground” pad for connecting to the ground plane 6-4₂ of the circuit board 6 of FIG. 2. In some embodiments, loop antennas have filter networks inserted into the antennas to achieve high Q in one of the bands.

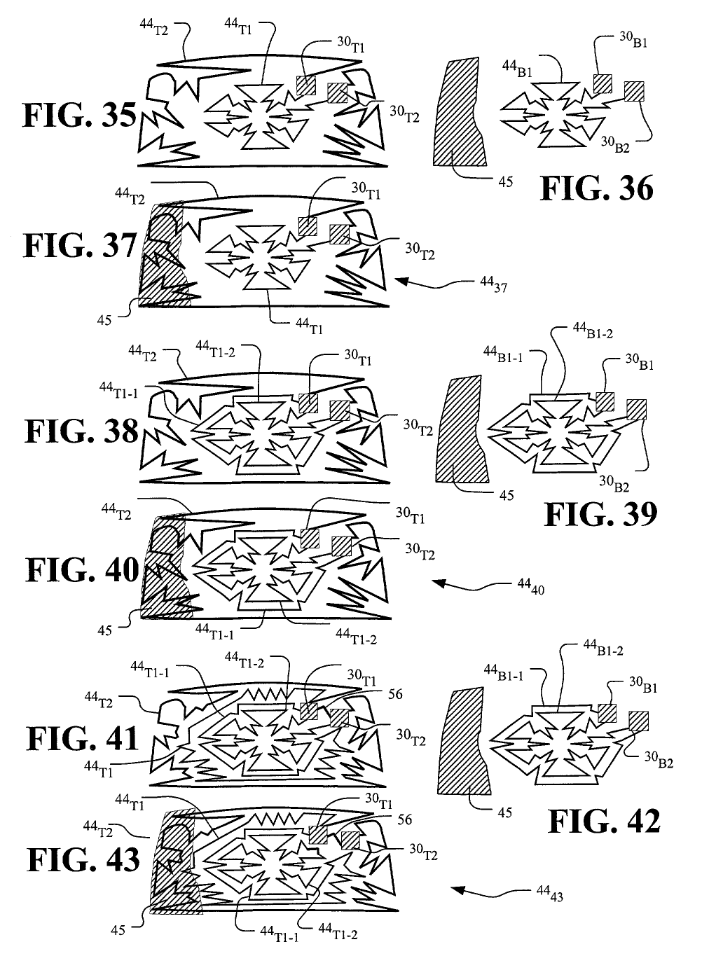

FIG. 36 depicts a top view of a bottom layer including a one-loop, 6-legged compressed antenna together with an irregular conducting pad that forms part of the multiband, multilayer compressed antenna with the layer of FIG. 35. The one-loop, 6-legged compressed antenna of FIG. 36 includes the one compressed loop 44_{B1-2} together with a conducting patch 45. The compressed loop 44_{B1-2} connects at one end to the pad 30_{B1} and connects at the other end to the pad 30_{B2}.

FIG. 37 depicts a top view of the multiband, multilayer compressed antenna 44₃₇ showing the layers of FIG. 35 and FIG. 36 superimposed as they would appear on the top and bottom of a dielectric substrate. The compressed antenna of FIG. 35 includes one compressed one-loop, 6-legged loop 44_{T1-2} surrounded by an irregular loop antenna 44_{T2} together with the irregular conducting patch 45. The compressed loop 44_{T1} connects at one end to the pad 30_{T1} and connects at the other end to the pad 30_{T2}. The irregular loop 44_{T2} connects at one end to the pad 30_{T1} and connects at the other end to the pad 30_{T2.}.

FIG. 38 depicts a top view of a top layer including a two-loop, 6-legged compressed antenna together with an irregular one-loop compressed antenna that forms part of a multiband, multilayer compressed antenna. The two-loop, 6-legged compressed antenna of FIG. 38 includes the two compressed loops 44_{T1-1} and 44_{T1-2} surrounded by one irregular loop antenna 44_{T2} The compressed loop antennas 44_{T1-1} and 44_{T1-2} connect at one end to the pad 30_{T1} and connect at the other end to the pad 30_{T2}. The irregular loop 44_{T2} connects at one end to the pad 30_{T1} and connect at the other end to the pad 30_{T2}.

FIG. 39 depicts a top view of a bottom layer including a two-loop, 6-legged compressed antenna together with an irregular conducting pad that forms part of the multiband, multilayer compressed antenna of FIG. 38. The two-loop, 6-legged compressed antenna of FIG. 39 includes the two compressed loop antennas 44_{B1-1} and 44_{B1-2} together with the irregular conducting patch 45. The compressed loop antennas 44_{B1-1} and 44_{B1-2} connect at one end to the pad 30_{B1} and connect at the other end to the pad 30_{B2}.

FIG. 40 depicts a top view of the multiband, multilayer compressed antenna 44₄₀ showing the layers of FIG. 38 and FIG. 39 superimposed as they would appear on the top and bottom of a dielectric substrate. The compressed antenna of FIG. 40 includes the two two-loop, 6-legged compressed loop antennas 44_{T1-1} and 44_{T1-2} surrounded by an irregular loop antenna 44_{T2} together with the irregular conducting patch 45. The compressed loops 44_{T1-1} and 44_{T1-2} connect at one end to the pad 30_{T1} and connect at the other end to the pad 30_{T2}. The irregular loop 44_{T2} connects at one end to the pad 30_{T1} and connects at the other end to the pad 30_{T2.}. The antenna of FIG. 40 employs loops that are nested to create a dual-band, band-pass antenna with good rejection between bands. Also, the antenna of FIG. 40 employs loops that are nested to a tri-band, band-pass antenna with good rejection between bands. The same basic antenna layout may be employed in different applications, such as dual-band and tri-band applications, using tuning techniques to adjust frequencies for any particular application.

FIG. 41 depicts a top view of a top layer including a two-loop, 6-legged compressed antenna together with an irregular two-loop compressed antenna that forms part of a multiband, multilayer compressed antenna. The two-loop, 6-legged compressed antenna of FIG. 41 includes the two compressed loop antennas 44_{T1-1} and 44_{T1-2} surrounded by two irregular loop antennas44_{T}1 and 44_{T2}. The compressed loop antennas 44_{T1-1} and 44_{T1-2} connect at one end to the pad 30_{T1} and connect at the other end to the pad 30_{T2}. The irregular loop antennas 44_{T1} and 44_{T2} connect at one end to the pad 30_{T1} and connect at the other end to the pad 30_{T2}. In FIG. 41, a pad interconnect 56 connects between the pad 30_{T1} and the pad 30_{T2.}. In FIG. 41, a pad interconnect 56 connects between the pad 30_{T1} and the pad 30_{T2.}. The pad interconnect 56 functions as a high-pass filter for the high frequency loop allowing low frequency signals (for example, 800-900 MHz) to short to ground. In some embodiments, filter networks are inserted into the antenna to achieve a high Q.

FIG. 42 depicts a top view of a bottom layer including a two-loop, 6-legged compressed antenna together with an irregular conducting pad that forms part of the multiband, multilayer compressed antenna of FIG. 41. The two-loop, 6-legged compressed antenna of FIG. 42 includes the two compressed loop antennas 44_{B1-1} and 44_{B1-2} together with the irregular conducting patch 45. The compressed loop antennas 44_{B1-1} and 44_{B1-2} connects at one end to the pad 30_{B1} and connect at the other end to the pad 30_{B2}.

FIG. 43 depicts a top view of the multiband, multilayer compressed antenna 44₄₃ showing the layers of FIG. 41 and FIG. 42 superimposed as they would appear on the top and bottom of a dielectric substrate. The compressed antenna of FIG. 43 includes the two two-loop, 6-legged compressed loop antennas 44_{T1-1} and 44_{T1-2} surrounded by two irregular loop antennas44_{T1} and 44_{T2} together with the irregular conducting patch 45. The compressed loop antennas 44_{T1-1} and 44_{T1-2} connect at one end to the pad 30_{T1} and connect at the other end to the pad 30_{T2}. The irregular loop antennas 44_{T1} and 44_{T2} connect at one end to the pad 30_{T1} and connect at the other end to the pad 30_{T2}.

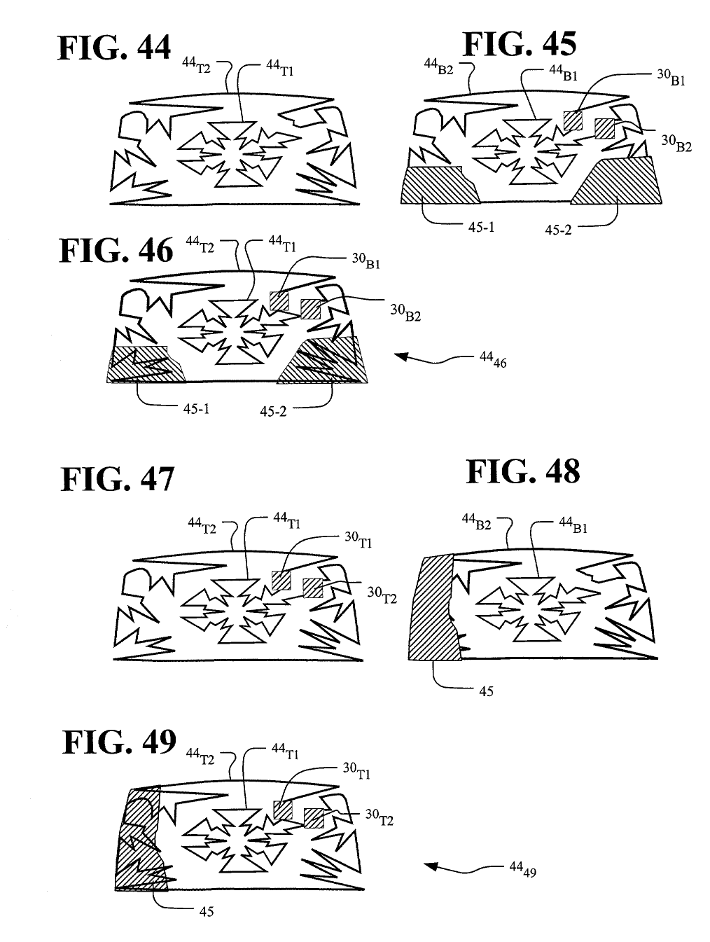

FIG. 44 depicts a top view of a top layer including a one-loop, 6-legged compressed antenna together with an irregular one-loop compressed antenna that forms part of a multiband, multilayer compressed antenna. The one-loop, 6-legged compressed antenna of FIG. 44 includes one compressed loop antenna 44_{T1} surrounded by an irregular loop antenna 44_{T2}. The compressed loop antenna 44_{T1} and irregular loop antenna 44_{T2} are closed loops that do not connect to any pads.

FIG. 45 depicts a top view of a bottom layer including a one-loop, 6-legged compressed antenna together with an irregular conducting pad that forms part of the multiband, multilayer compressed antenna with the layer of FIG. 44. The one-loop, 6-legged compressed antenna of FIG. 45 includes the one compressed loop 44_{B1} together with two irregular conducting patches 45-1 and 45-2. The compressed loop 44_{B1} connects at one end to the pad 30_{B1} and connects at the other end to the pad 30_{B2}. The irregular loop 44_{B2} connects at one end to the pad 30_{B1} and connects at the other end to the pad 30_{B2}. The two irregular conducting patches 45-1 and 45-2 are eclectically connected to the irregular loop 44_{B2} and function together with the loop 44_{T2.} to establish the desired frequency band.

FIG. 46 depicts a top view of the multiband, multilayer compressed antenna 44₄₆ showing the layers of FIG. 44 and FIG. 45 superimposed as they would appear on the top and bottom of a dielectric substrate. The compressed antenna of FIG. 44 includes one compressed one-loop, 6-legged loop 44_{T1} surrounded by an irregular loop antenna 44_{T2} together with the irregular conducting patches 45-1 and 45-2. The compressed loop 44_{T1} connects at one end to the pad 30_{T1} and connects at the other end to the pad 30_{T2}. The irregular loop 44_{B2} situated below the irregular loop 44_{T2} connects at one end to the pad 30_{T1} and connects at the other end to the pad 30_{T2}.

FIG. 47 depicts a top view of a top layer including a one-loop, 6-legged compressed antenna together with an irregular one-loop compressed antenna that forms part of a multiband, multilayer compressed antenna. The one-loop, 6-legged compressed antenna of FIG. 35 includes one compressed loop antenna 44_{T1} surrounded by an irregular loop antenna 44_{T2}. The compressed loop antenna 44_{T1} connects at one end to the pad 30_{T1} and connects at the other end to the pad 30_{T2}. The irregular loop antenna 44_{T2} connects at one end to the pad 30_{T1} and connects at the other end to the pad 30_{T2.}.

FIG. 48 depicts a top view of a bottom layer including a one-loop, 6-legged compressed antenna together with an irregular conducting pad that forms part of the multiband, multilayer compressed antenna with the layer of FIG. 44. The one-loop, 6-legged compressed antenna of FIG. 48 includes the one compressed loop 44_{B1} electrically connected to an irregular conducting patches 45. The compressed loop antenna 44_{B1} and irregular loop antenna 44_{B2} are closed loops that do not connect to any pads. The irregular conducting patches 45 is eclectically connected to the irregular loop 44_{B2} and function together with the loop 44_{T2.} to establish the desired frequency band.

FIG. 49 depicts a top view of the multiband, multilayer compressed antenna 44₄₉ showing the layers of FIG. 47 and FIG. 48 superimposed as they would appear on the top and bottom of a dielectric substrate. The compressed antenna of FIG. 49 includes one compressed one-loop, 6-legged loop 44_{T1} (over a compressed loop 44_{B1}) surrounded by an irregular loop antenna 44_{T2} (over a compressed loop 44_{B2}) together with the irregular conducting patch 45. The compressed loop 44_{T1} connects at one end to the pad 30_{T1} and connects at the other end to the pad 30_{T2}. The irregular loop 44_{T2} situated over the loop 44_{T2} connects at one end to the pad 30_{T1} and connects at the other end to the pad 30_{T2}.

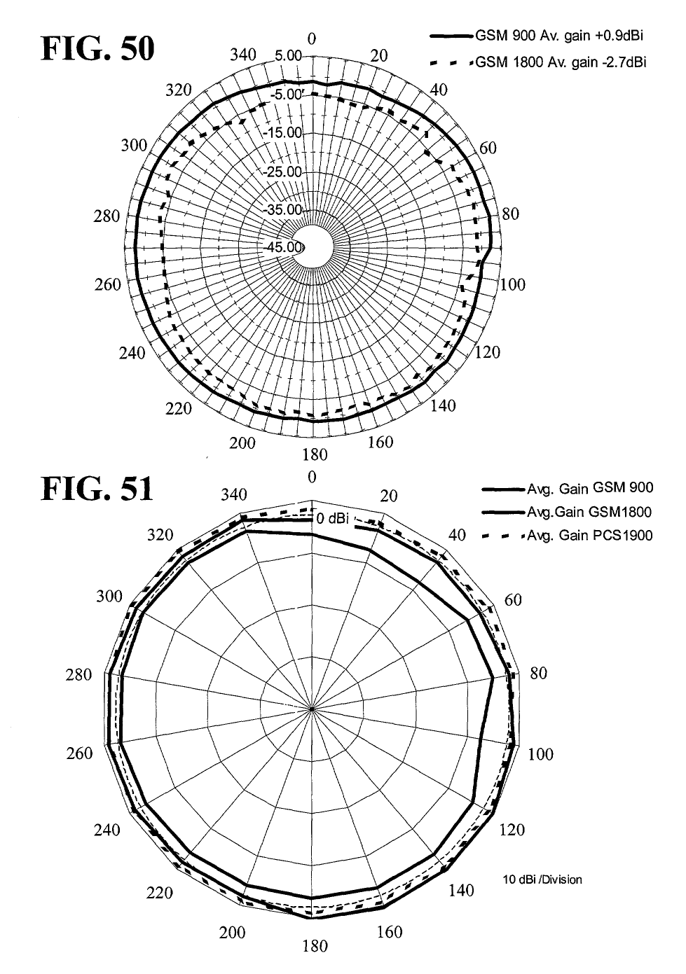

FIG. 50 depicts a two-dimensional representation of the field pattern of the antenna structure of FIG. 40 for the GSM 900 MHz and GSM 1800 MHz bands.

FIG. 51 depicts a two-dimensional representation of the field pattern of the antenna structure of FIG. 40 for the GSM 900 MHz, GSM 1800 MHz and PCS 1900 MHz band s.

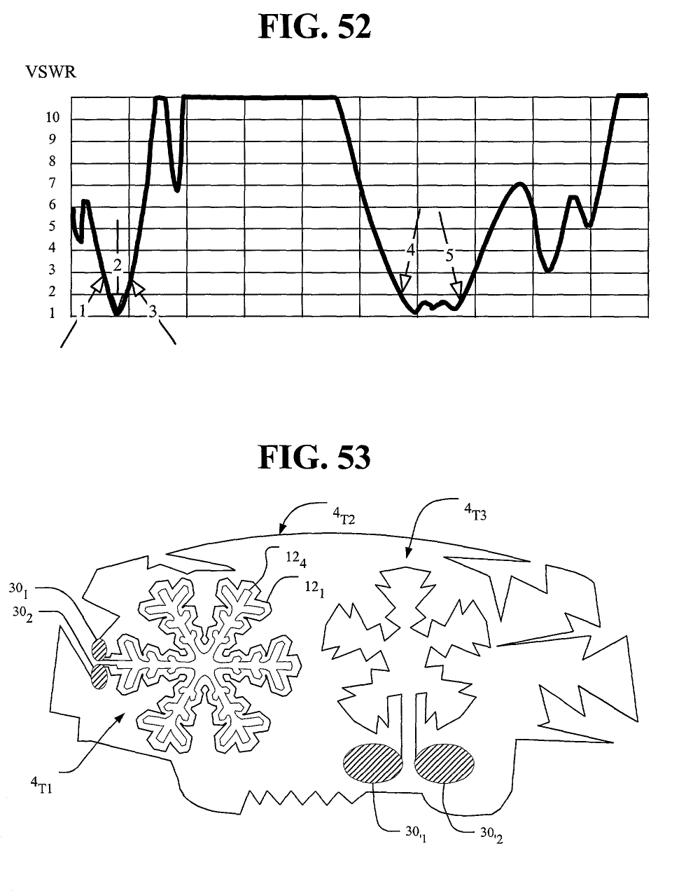

FIG. 52 depicts a voltage standing wave ratio (VSWR) representation of the antenna of FIG. 40. The FIG. 40 antenna has VSWR as follows:

| ARROW | FREQUENCY | VSWR |
|---|---|---|
| 1 | 880 MHz | 2.93 |
| 2 | 920 MHz | 1.13 |
| 3 | 980 MHz | 2.94 |
| 4 | 1.71 GHz | 2.09 |
| 5 | 1.88 GHz | 1.72 |

FIG. 53 depicts a top view of an outer irregular compressed loop with an inner two-loop, 6-legged compressed antenna, similar to the antenna of FIG. 12, together with a separate inner one-loop, 5-legged compressed antenna, similar to the antenna of FIG. 17. The antenna of FIG. 53 is a quad-band antenna and by addition of additional loops may add still additional bands.

In FIG. 53, the two-loop, 6-legged compressed antenna 4_{T1} is nested within the irregular compressed loop 4_{T2}. The compressed antenna 4_{T1} has a snowflake pattern formed of compressed loops 12₁ and 12₄, as described in connection with FIG. 13. The compressed loops 12₁ and 12₄ and the irregular compressed loop 4_{T2} all connect at one end to the pad 30₁ and all connect at the other end to the pad 30₂. The compressed loops 12₁, 12₄ and compressed loop 4_{T2} are nested on the same layer and the area enclosed by each of the more outer ones of the loops encloses the area enclosed by the more inner ones of the loops

In FIG. 53, the one-loop, 5-legged compressed antenna 4_{T3}, is similar to that shown in FIG. 17, and connects at one end to the pad 30′₁ and connects at the other end to the pad 30′₂. The 5-legged compressed antenna 4_{T3} is arrayed on the same layer and nested within the antenna 4_{T2}. The compressed loops 12₁, 12₄ and the compressed loop 4_{T2} are not superimposed, but are separated from each other while being nested within compressed loop 4_{T2}.

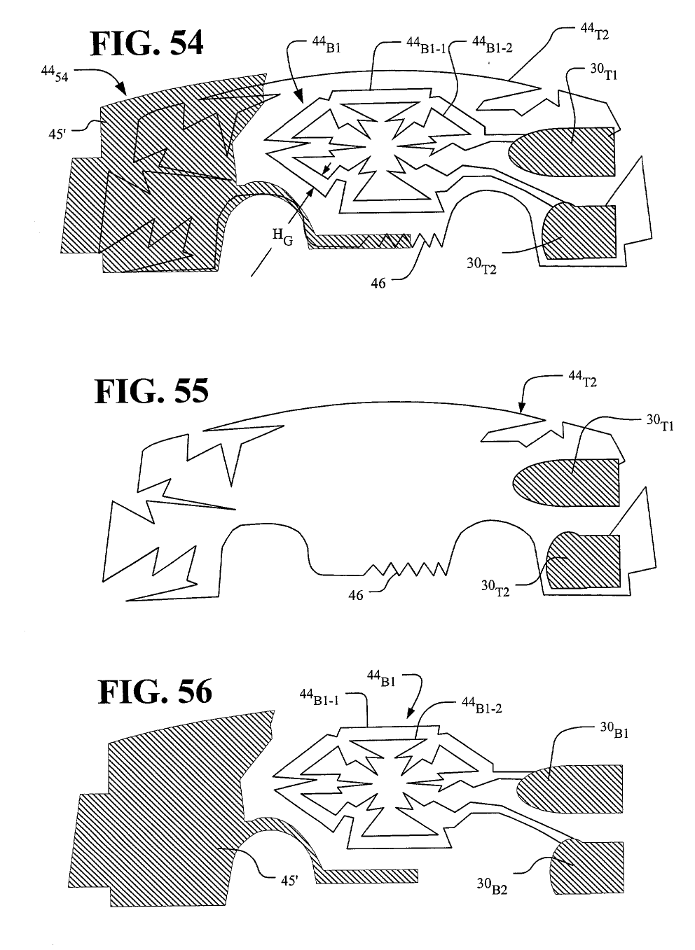

FIG. 54 depicts a top view of an antenna structure including compressed loops above and below a substrate and is a variant of the FIG. 22 antenna. The multi-loop antenna 44 of FIG. 54 includes a first compressed loop 44_{B1} on a bottom layer generally surrounded by a second compressed loop 44_{T2} on a top layer layer. The loop 44_{T2} is connected at each end to connection pads 30_{T1} and 30_{T2}. The loops 44_{B1} and 44_{T2} generally lie in the XY-plane and have magnetic current in the Z-axis direction normal to the XY-plane. The loop 44_{B1} is formed of two concentric loops, namely, sub-loops 44_{B1-1} and 44_{B1-2}, where sub-loop 44_{B1-2} is nested within sub-loop 44_{B1-1}.

FIG. 55 depicts a top view of the top layer of the antenna structure of FIG. 54. The loop 44_{T2} is connected at each end to connection pads 30_{T1} and 30_{T2}. The top layer of FIG. 55 differs from the top layer of FIG. 22 in that top layer of FIG. 55 does not include a double loop which corresponds to the compressed loop44_{B1-1} on the bottom layer.

FIG. 56 depicts a top view of the bottom layer of the antenna of FIG. 54. The bottom layer includes the double nested loop 44_{B1} including the first compressed loop 44_{B1-1} surrounding a second compressed loop 44_{B1-2}. The bottom layer also includes a conductive patch 45′ that serves as a ground or parasitic patch that functions to tune the antenna 44 and particularly loop 44_{T2}.

In the embodiment of FIG. 54 through FIG. 56, connection pads 30_{B1} and 30_{B2} capacitively couple the pads 30_{T1} and 30_{T2} whereby the compressed loops 44_{T2} and 44_{B1} are connected in common and are connected through the connection element 3 to the transceiver on circuit board 6 of FIG. 2. The capacitive coupling between the connection pads 30_{B1} and 30_{B2} and the pads 30_{T1} and 30_{T2} for the compressed loops 44_{T2} and 44_{B1} functions as a high-pass filter. The high-pass filter allows the higher frequencies to pass to the compressed loop 44_{B1} and to be filtered from the lower frequency band of compressed loop 44_{T2}. This filtering aides in the separation of the pass bands for the compressed loops 44_{T2} and 44_{B1}.

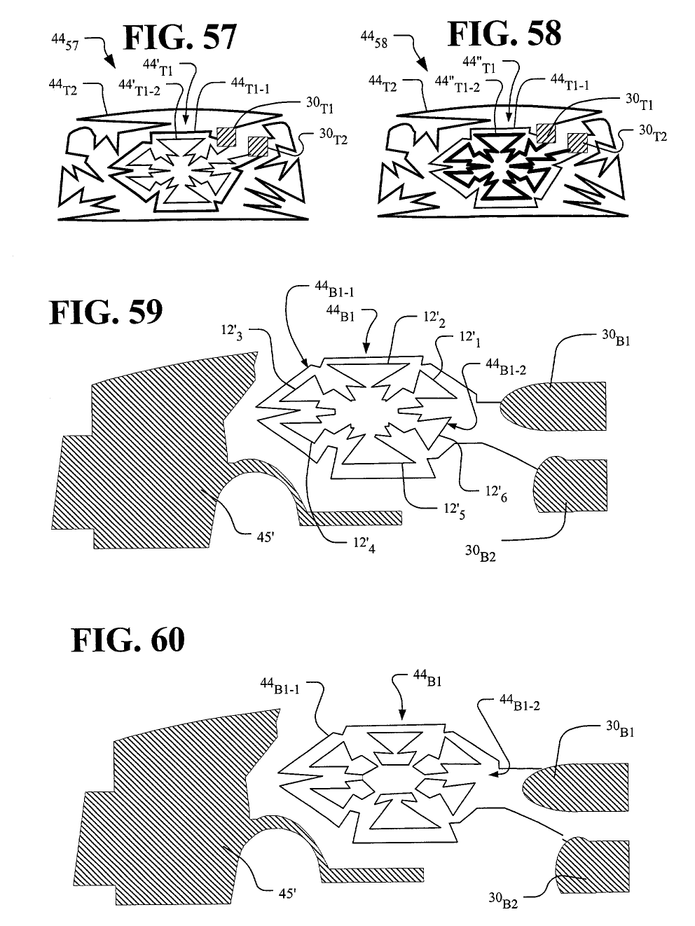

FIG. 57 depicts a top view of an antenna 44₅₇ including an outer irregular compressed loop 44_{T2} and an inner two-loop, 6-legged compressed loop 44′_{T1}. The compressed loop antennas 44_{T1-1} and 44′_{T1-2} connect at one end to the pad 30_{T1} and connect at the other end to the pad 30_{T2}. The irregular loop 44_{T2} connects at one end to the pad 30_{T1} and connects at the other end to the pad 30_{T2}. In the embodiment of FIG. 57, the width of the trace of the inner loop 44′_{T1-2} is narrower than the trace of the inner loop 44_{T1-1}.

FIG. 58 depicts a top view of an antenna 44₅₈ including an outer irregular compressed loop 44_{T2} and an inner two-loop, 6-legged compressed loop 44″_{T1.} The compressed loop antennas 44_{T1-1} and 44″_{T1-2} of the compressed loop 44″_{T1} connect at one end to the pad 30_{T1} and connect at the other end to the pad 30_{T2}. The irregular loop 44_{T2} connects at one end to the pad 30_{T1} and connects at the other end to the pad 30_{T2}. The trace of the inner loop 44″_{T1-2} is wider than the trace of the inner loop 44′_{T1-2} of the two-loop compressed antenna of FIG. 57. This variation in trace width (variation of A_{T2} in FIG. 4) between the compressed loop 44″_{T1} of FIG. 58 and the compressed loop 44′_{T1} of FIG. 57 alters the parameters of the antenna and a variation is used to tune antennas. In general, increasing the trace width of any loop, or segment of a loop, decreases the inductance of the loop and generally increases the coupling to nearby traces of other loops. In one example, a change from a width (A_{T2} in FIG. 4) of about 3 mil (0.08 mm) to about 13 mil (0.33 mm) changes the frequency from 10 to 15 MHz between 800 MHz and 2000 MHz. Other similar changes might be expected up to 50 MHz and more.

FIG. 59 depicts a top view of an alternate embodiment of a bottom layer of an antenna structure like that of FIG. 22, where the FIG. 59 bottom layer is similar to the bottom layer of FIG. 25. In FIG. 59, the inner loop 44_{B1-2} of the two-loop compressed antenna 44_{B1} is closed and floating while the outer loop 44_{B1-1} is connected to the connection pads 30_{B1} and 30_{B2}. The inner loop 44_{T1} is closed and floating, that is, not connected to any pad. With the inner loop 44_{T1-1} floating, the antenna characteristics are altered as compared with a non-floating embodiment such as shown in FIG. 24. Because the inner and outer loops of antenna 44_{T1} are in close proximity, they remain coupled and the floating compressed loop 44_{B1} has a substantial effect on the properties of the overall antenna. Among other reasons, because the inner loop 44_{B1-2} is a mirror image of the inner loop 44_{T1-2} of an upper layer (for example, see the upper layer of FIG. 24), the inner loop 44_{B1-2} of FIG. 59 is coupled to and forms part of the overall multi-loop antenna that is formed.

FIG. 60 depicts a top view of an alternate embodiment of a bottom layer of an antenna structure like that of FIG. 22, where the FIG. 60 bottom layer is similar to the bottom layer of FIG. 25. In FIG. 60, the inner loop 44_{B1-2} of the two-loop compressed antenna 44_{B1} is formed of six legs, specifically the six legs 12′-1,12′-2,12′-3, 12′-4, 12′-5 and 12′-6, where each of the legs is closed and floating. Among other reasons, because each of the six legs 12′-1,12′-2,12′-3, 12′-4, 12′-5 and 12′-6 is substantially a mirror image of a leg of the inner loop 44_{T1-2} of an upper layer (for example, see the upper layer of FIG. 24), the inner loop 44_{B1-2} formed of the six legs 12′-1,12′-2,12′-3, 12′-4, 12′-5 and 12′-6 is coupled to and forms part of the overall multi-loop antenna that is formed.

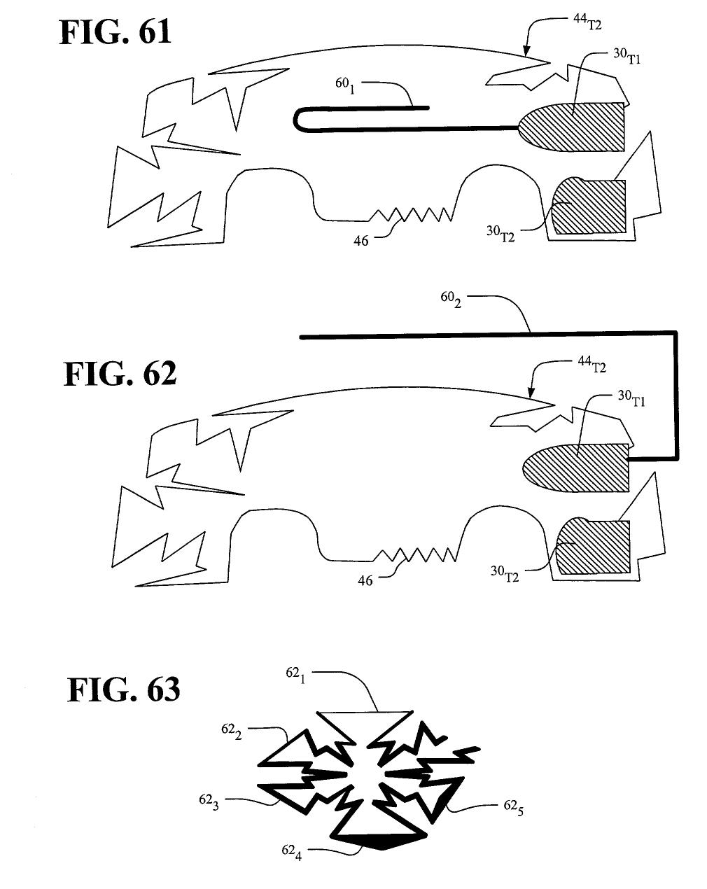

FIG. 61 depicts a top view of a top layer having a tuning element in the form of tuning stub 60₁. The top layer of FIG. 61 is similar to the top layer of FIG. 55. The top layer of FIG. 61 replaces the top layer in the loop antenna44₅₄ of FIG. 54 to form an alternate loop antenna embodiment with a tuning element. The tuning stub 60₁ is internal to a loop in that it is situated internal to an area enclosed by loop 44_{T2} of FIG. 61. The tuning stub 60₁ adds inductance to the irregular compressed loop 44_{T2} in proportion to the length and other dimensions of tuning stub 60₁. As a part of the design and manufacture of the loop antenna, the length of the tuning stub 60₁ is a tuning parameter varied to tune the irregular loop 44_{T2} and the overall loop antenna formed. The tuning method includes forming a first instantiation of said loop antenna with a first value for the length of tuning stub 60₁. Thereafter, the first instantiation of the loop antenna is tested to determine the loop antenna properties. Thereafter, one or more subsequent instantiations of the loop antenna are made with subsequent instantiations having modifications of the length of stub 60₁. The steps of forming, testing and modifying are repeated until the properties of the loop antenna are acceptable.

In general, one or more tuning parameters (such as length, width, thickness, pattern, location and relative location) exist for any loop antenna element including, for example, tuning stubs, pads, loops, traces, substrates and connectors. The tuning parameters are selected individually or in combination. Loop antennas are made with tuning parameters so that the loop antennas ultimately manufactured are suitable for use with a communication device to exchange energy in particular selected bands of radiation frequencies. The method of making a loop antenna includes the steps of forming loops, testing the antenna formed of the loops and modifying the loop antenna so formed. One or more of the steps are repeated until the properties of the loop antenna are acceptable. In particular, the forming step forms two or more radiation loops having a tuning parameter on a dielectric substrate wherein at least one of the loops is arrayed in a compressed pattern and wherein the loops are superimposed such that an area enclosed by one of the loops covers an area enclosed by another of the loops. The testing step tests the loop antenna to determine properties of the loop antenna. The modifying step modifies a tuning parameter. The method includes a number of tuning embodiments including embodiments where a tuning parameter is the length of a tuning section connected in series with a loop (see FIG. 22, FIG. 29, FIG. 31); a tuning parameter is a gap between loops (see FIG. 22); a tuning parameter is a width of one or more segments (see FIG. 57, FIG. 58, FIG. 63); a tuning parameter is one or more tapered segments (see FIG. 63); a tuning parameter is a length of a stub situated internal to a loop (see FIG. 61); a tuning parameter is a length of a stub situated external to a loop (see FIG. 62); a tuning parameter is a relative location of juxtaposed loops (see FIG. 3); a tuning parameter is a length of one or more of the loops (see FIG. 22). The steps in still further embodiments include the step of simulating the antenna operation and, when desired, the step of simulating the antenna operation is repeated after one or more of the modifying steps. The simulation employs computer program analysis, test equipment analysis and/or other well-known methods of antenna simulation.

FIG. 62 depicts a top view of a top layer, similar to the top layer of FIG. 55, having an external tuning stub 60₂. The stub 60₂ is external in that it is situated external to an area enclosed by a loop antenna, specifically antenna loop 44_{T2} of FIG. 62. The tuning stub 60₂ adds inductance to the irregular compressed loop 44_{T2} in proportion to the length of trace of tuning stub 60₁. Additionally, the tuning stub 60₂ acts as a linear antenna that provides additional frequencies (proportional to the electrical length of the stub 60₂) to the frequency band of the overall antenna formed.

The tuning of compressed loops and compressed antennas is important in designing and manufacturing of antennas with the desired bands of operation. The tuning may include variations of an entire loop, for many segments of a loop or for one or a few segments. Also, the use of a first trace (loop), for example on one layer, and the use of a juxtaposed trace (loop), for example on another layer, permits changes in the dimensions or the locations of either one or both of the juxtaposed traces to tune the antenna. Changing the dimensions of juxtaposed traces changes the capacitive and other coupling between the traces thereby facilitating tuning. Frequency shifts by as much as 100 MHz or more are possible. The use of tuning elements such as tuning stubs, variations in trace widths, variations in trace lengths, changes in loop locations, gaps between loops, the size and location of capacitive pads and other elements of antennas can all be used alone or in combination for tuning.

FIG. 63 depicts a top view of a one-loop, 6-legged compressed antenna that forms part of an overall antenna where different segments of the 6-legged compressed loop have different thicknesses and shapes. Specifically, segment 62₁ has a narrow width compared with other segments of loop 44₆₃. Segment 62₂ has an intermediate width compared with other segments of loop 44₆₃. Segment 62₃ has a large width compared with segment 62₁ and segment 62₂. Segments 62₄ and 64₅ have irregular widths (tapering from narrow at the ends to wide at the middle) compared with other segments of loop 44₆₃. The different widths and shapes of segments are used to tune loops in order to achieve the desired overall antenna characteristics.

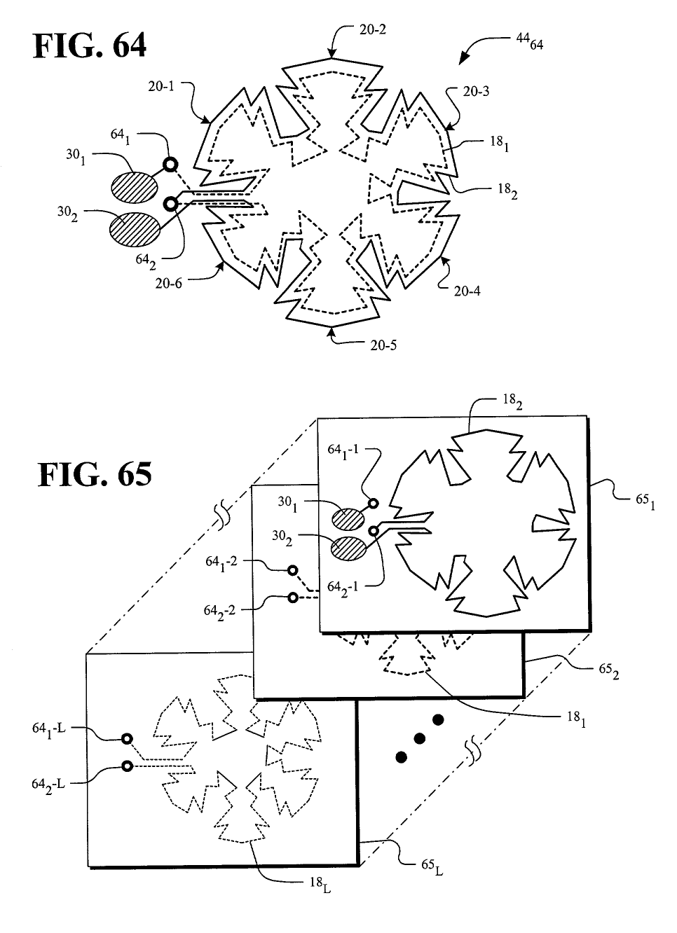

FIG. 64 depicts a top view of a two-loop, 6-legged compressed antenna 44₆₄ formed by a first loop 18₁ on a first layer and formed by a second loop 18₂ on a second layer. The second loop 18₂ is a slightly reduced in size mirror image of the first loop 18₁. Since the loops are on different layers, they can be the same size and shape. Alternatively, the loops can be of different sizes and shapes and be fully or partially superimposed. One end of the loop 18₁ connects to pad 30₂ and the other end connects to the via 64₂. One end of the loop 18₂ connects through the via 64₁ to pad 30₁ and the other end connects to the via 64₂. With these connections, an electric current from pad 30₂ to pad 30₁ is serially first in loop 18₁ and then second in loop 18₂. The current is counterclockwise in both loops 18₁ and 18₂ and therefore, loops 18₁ and 18₂ form a two-turn antenna 44₆₄. Alternatively, the via connections can be changed so that the loops are connected in parallel (similar to the loops 18₁ and 18₂ in FIG. 20 except not on the same layer and having vias in place of the transmission line conductors).

FIG. 65 depicts a top view of a two-loop, 6-legged compressed antenna 44₆₄ formed on multiple layers 65₁, 65₂, . . . , 65_{L}. Each of the layers is a dielectric material supporting conducive traces. The first two layers 65₁ and 65₂ are like the antenna 44₆₄ shown in FIG. 64. The first loop 18₁ is situated on the top of layer 65₁. The second loop 18₂ is situated on the top of layer 65₂ or alternatively on the bottom of layer 65₁. One end of the loop 18, connects to pad 30₂ and the other end connects to the part of the via 64₂-1 on layer 65₁. The pad 30, connects to the part of the via 64₁-1 on layer 65₁.

In FIG. 65, the loop 18₂ connects at one end to the part of the via 64₂-2 on layer 65₂ and the other end connects to the part of the via 64₁-2 on layer 65₂. With these connections, an electric current from pad 30₂ to pad 30₁ is serially first in loop 18₁ and then second in loop 18₂. The current is counterclockwise in both loops 18₁ and 18₂ and therefore, loops 18₁ and 18₂ form a two-turn antenna 44₆₄ in the same manner as FIG. 64.

In FIG. 65, the loop 18_{L} connects at one end to the part of the via 64₂-L on layer 65_{L} and the other end connects to the part of the via 64₁-L on layer 65_{L}. With these connections the loop 18_{L} is connected in parallel with the loop 18₂

The loop antennas described in the various antenna embodiments operate in cellular frequencies of the world including those of North America, South America, Europe, Asia Australia. The cellular frequencies are used when the communication device is a mobile phone, PDA, portable computer, telemetering equipment or any other wireless device. The loop antennas described in the various antenna embodiments operate to transmit and/or receive in mobile telephone frequency bands, for example, anywhere from 800 MHz to 2500 MHz.

While many different embodiments of compressed antennas have been described, the different features and variations of each embodiment may be readily transferred to other embodiments. A feature on one loop of an antenna may be transferred to another loop of the antenna. The interaction of multiple loops in a multi-loop antenna fosters the interchangeability of features from loop to loop.

While the invention has been particularly shown and described with reference to preferred embodiments thereof it will be understood by those skilled in the art that various changes in form and details may be made therein without departing from the scope of the invention.

1. (Original) A loop antenna, for use with a communication device, operating for exchanging energy in bands of radiation frequencies, comprising,
connection means for conduction of electrical current,
two or more radiation loops wherein,
each loop includes a plurality of electrically conducting segments, each segment having a segment length, where the segments are electrically connected in series to said connection means to form a loop antenna for exchange of energy in one of said bands of radiation frequencies,
at least one of said loops has said segments arrayed in a compressed pattern,
said loops are superimposed whereby an area enclosed by one of said loops covers an area enclosed by another of said loops.

2. (Original) The loop antenna of claim 1 wherein said loops are nested where an area enclosed by one of said loops is within an area enclosed by another of said loops.

3. (Original) The loop antenna of claim 2 wherein a first one of said loops is offset from a second one of said loops by a gap.

4. (Original) The loop antenna of claim 3 wherein said gap is a tuned gap.

5. (Original) The loop antenna of claim 3 wherein said gap is a tuned gap of approximately 0.69 mm.

6. (Original) The loop antenna of claim 3 wherein said tuned gap is less than approximately 10 mm for a US PCS band operating from 1850 MHz to 1990 MHz, a European DCS band operating from 1710 MHz to 1880 MHz, a European GSM band operating from 880 MHz to 960 MHz and a US cellular band operating from 829 MHz to 896 MHz.

7. (Original) The loop antenna of claim 1 wherein said loops are nested in a single plane where an area enclosed by one of said loops is within an area enclosed by another of said loops.

8. (Original) The loop antenna of claim 7 wherein said plane is flat.

9. (Original) The loop antenna of claim 7 wherein said plane is curved.

10. (Original) The loop antenna of claim 1 wherein said loops are nested on the same layer supported by a dielectric substrate where an area enclosed by one of said loops is within an area enclosed by another of said loops.

11. (Original) The loop antenna of claim 1 wherein said loops are on different layers supported by a dielectric substrate.

12. (Original) The loop antenna of claim 1 wherein said loops include two or more loops where each of said loops is a 2-legged compressed loop antenna.

13. (Original) The loop antenna of claim 1 wherein said loops include two or more loops where each of said loops is a 3-legged compressed loop antenna.

14. (Original) The loop antenna of claim 1 wherein said loops include two or more loops where each of said loops is a 4-legged compressed loop antenna.

15. (Original) The loop antenna of claim 1 wherein said loops include two or more loops where each of said loops is a 5-legged compressed loop antenna.

16. (Original) The loop antenna of claim 1 wherein said loops include two or more loops where each of said loops is a 6-legged compressed loop antenna.

17. (Original) The loop antenna of claim 1 wherein said 6-legged compressed antenna has a snowflake pattern.

18. (Original) The loop antenna of claim 1 wherein said connection means includes a transmission line connected to said compressed antennas.

19. (Original) The loop antenna of claim 1 wherein said compressed antennas are mounted on a flexible dielectric substrate.

20. (Original) The loop antenna of claim 1 wherein a majority of said segments are straight and arrayed in multiple divergent directions not parallel to an orthogonal coordinate system so as to provide a long antenna electrical length while permitting the overall outside dimensions of said loop to fit within an antenna area of said communication device.

21. (Original) The loop antenna of claim 1 wherein said connection means includes contact areas for coupling to a transceiver of said communication device.

22. (Original) The loop antenna of claim 1 wherein said connection means includes at least one compressible metal tang.

23. (Original) The loop antenna of claim 1 wherein said connection means includes two compressible metal tangs that have substantially the same spring compression for making balanced electrical connections to first and second conductors.

24. (Original) The loop antenna of claim 1 wherein said radiation loop has an irregular shape and wherein said segments are arrayed in an irregular compressed pattern.

25. (Original) The loop antenna of claim 1 wherein said segments of one or more of said loops are situated on a flexible dielectric substrate.

26. (Original) The loop antenna of claim 1 wherein said radiation loops transmit and receive radiation.

27. (Original) The loop antenna of claim 1 wherein said radiation loops transmit and receive in the US PCS band operating from 1850 MHz to 1990 MHz.

28. (Original) The loop antenna of claim 1 wherein said radiation loops transmit and receive in a European DCS band operating from 1710 MHz to 1880 MHz.

29. (Original) The loop antenna of claim 1 wherein said radiation loops transmit and receive in a European GSM band operating from 880 MHz to 960 MHz.

30. (Original) The loop antenna of claim 1 wherein said radiation loops transmit and receive in b a US cellular band operating from 829 MHz to 896 MHz.

31. (Original) The loop antenna of claim 1 wherein said radiation loops transmit and receive in mobile telephone frequency bands anywhere from 800 MHz to 2500 MHz.

32. (Original) The loop antenna of claim 1 wherein a first one of said radiation loops is nested within a second one of said radiation loops and wherein said first one and said second one of said radiation loops are different in lengths by amounts that establish radiation frequencies that partially overlap and produce combined radiation to establish a combined bandwidth greater than a bandwidth for either said first one and said second one of said radiation loops alone.

33. (Original) The loop antenna of claim 1 wherein one or more first ones of said radiation loops and one or more said second ones of said radiation loops are different in lengths by amounts that establish radiation frequencies that do not substantially overlap and thereby produce combined radiation frequencies for said first ones and said second ones of said radiation loops to establish first and second bands of said frequencies that are separated and do not substantially overlap.

34. (Original) The loop antenna of claim 1 wherein one or more of said radiation loops is on one layer mounted on a dielectric material and one or more other ones of said radiation loops is on a different layer mounted on said dielectric material.

35. (Original) The loop antenna of claim 1 wherein a first one of said radiation loops is on one layer mounted on a dielectric material and where a conductive region is on a different layer mounted on said dielectric material juxtaposed said first one of said radiation loops.

36. (Original) The loop antenna of claim 1 wherein each of said loops have first and second termination points where said first termination points for each of said loops connect together in common at a first pad, where said second termination points for each of said loops connect together in common at a second pad and where said first and second pads connect all of said loops in said communication device.

37. (Original) The loop antenna of claim 36 wherein said loops provide multi-band performance.

38. (Original) The loop antenna of claim 1 wherein said bands of frequencies are not harmonically related.

39. (Original) The loop antenna of claim 1 formed of multiple layers and includes a parasitic patch on one layer juxtaposed an area of one of said loops on another layer to tune the antenna.

40. (Original) The loop antenna of claim 1 formed of multiple layers and a plurality of parasitic patches, each of said patches on one of said layers juxtaposed an area of one of said loops on another of said layers to tune the antenna.

41. (Original) The loop antenna of claim 39 wherein said plurality of parasitic patches are electrically connected.

42. (Original) The loop antenna of claim 34 wherein said plurality of parasitic patches are not electrically connected.

43. (Original) The loop antenna of claim 1 where said loops are nested to create a dual-band, band-pass antenna with good rejection between bands.

44. (Original) The loop antenna of claim 1 where said loops are nested to create a tri-band, band-pass antenna with good rejection between bands.

45. (Original) The loop antenna of claim 1 where said loops are nested to create a quad-band, band-pass antenna with good rejection between bands.

46. (Original) The loop antenna of claim 1 where said loops are located on any one of a plurality of layers.

47. (Original) The loop antenna of claim 1 where one or more of said loops are nested and connected to form a closed loop.

48. (Original) The loop antenna of claim 47 where one or more of said closed loops are floating.

49. (Original) The loop antenna of claim 47 wherein a first one of said closed loops is nested within a second one of said radiation loops and wherein said first one and said second one of said radiation loops are different in lengths by amounts that establish radiation frequencies that partially overlap and produce combined radiation frequencies to establish a combined bandwidth greater than a bandwidth for either said first one and said second one of said radiation loops alone.

50. (Original) The loop antenna of claim 1 wherein a first one of said radiation loops is nested within a second one of said radiation loops and wherein said first one and said second one of said radiation loops have a similar shape with an offset gap that establishes radiation frequencies that partially overlap and produce combined radiation frequencies to establish a combined bandwidth greater than a bandwidth for either said first one and said second one of said radiation loops alone.

51. (Original) The loop antenna of claim 1 wherein a first one of said radiation loops is nested within a second one of said radiation loops and wherein said first one and said second one of said radiation loops have dissimilar shapes that establishes multiband radiation frequencies and produce combined radiation frequencies for said first one and said second one of said radiation loops to establish multiband operation.

52. (Original) The loop antenna of claim 1 where said loops are formed with two or more legs.

53. (Original) The loop antenna of claim 52 where said legs are arrayed with a periodically repeating pattern.

54. (Original) The loop antenna of claim 52 wherein each of said legs includes a plurality of straight segments arrayed in a plurality of different directions.

55. (Original) The loop antenna of claim 1 wherein said loops are formed of an irregular pattern of segments arrayed with non-repeating perturbations.

56. (Original) The loop antenna of claim 1 wherein said loops are formed of an irregular pattern of segments arrayed with repeating perturbations.

57. (Original) The loop antenna of claim 1 wherein one or more of said loops includes a tuning element that tunes the antenna.

58. (Original) The loop antenna of claim 57 wherein said tuning element is adjusted in length to adjust a length of a loop without substantially altering antenna shape.

59. (Original) The loop antenna of claim 57 wherein said tuning element has a rectangular wave shape.

60. (Original) The loop antenna of claim 57 wherein said tuning element has a sinusoidal wave shape.

61. (Original) The loop antenna of claim 57 wherein said tuning element has an irregular shape.

62. (Original) The loop antenna of claim 57 wherein said tuning element is a linear element arrayed internal to a loop.

63. (Original) The loop antenna of claim 57 wherein said tuning element is a linear element arrayed external to a loop.

64. (Original) The loop antenna of claim 63 wherein said linear element adds a resonant frequency to said loop antenna.

65. (Original) The loop antenna of claim 1 wherein said antenna operates in one or more of the bands including an HF band from 3 to 30 MHz, a VHF band from 30 to 300 MHz, a UHF band from 300 MHz to 3 GHz, a SHF band from 3 to 30 GHz and an EHF band from 30 to 300 GHz band.

66. (Original) The loop antenna of claim 1 wherein said antenna operates in the any combination of bands from a group of bands including an HF band from 3 to 30 MHz, a VHF band from 30 to 300 MHz, a UHF band from 300 MHz to 3 GHz, a SHF band from 3 to 30 GHz and an EHF band from 30 to 300 GHz band.

67. (Original) The loop antenna of claim 1 wherein said antenna operates in the any combination of bands from a group of bands in the range from 3 MHz to 300 Ghz.

68. (Original) The loop antenna of claim 1 where said loops include two or more loops where each of said loops is a six-legged compressed loop antenna with one or more sublegs on each of said legs.

69. (Original) The loop antenna of claim 68 where each leg includes six sublegs.

70. (Original) The loop antenna of claim 1 where said loops include two or more loops where each of said loops is a multi-legged compressed loop antenna with from one to six sublegs on each leg.

71. (Original) The loop antenna of claim 1 wherein said loops are nested on the same layer where an area enclosed by a first one of said loops is within an area enclosed by a second one of said loops and where one or more loop interconnects connect between said first one of said loops and said second one of said loops to improve the VSWR or return loss of the antenna.

72. (Original) The loop antenna of claim 1 wherein said loops are nested on the same layer where an area enclosed by a first one of said loops is within an area enclosed by a second one of said loops and where one or more loop interconnects connect between said first one of said loops and said second one of said loops to improve the far field gain performance of the antenna.

73. (Original) The loop antenna of claim 1 wherein said loops are nested where an area enclosed by a first one of said loops is juxtaposed an area enclosed by a second one of said loops and where only one of said loops is physically connected to the circuit board and all other of said loops are not physically connected to said one of said loops.

74. (Original) The loop antenna of claim 1 where some of said nested loops are connected at the a drive point to form drive loops and other of said loops are unconnected loops not physically connected to the drive loops and wherein said unconnected loops are floating.

75. (Original) The loop antenna of claim 74 where said unconnected loops are open.

76. (Original) The loop antenna of claim 74 where said unconnected loops are closed.

77. (Original) The loop antenna of claim 1 formed of multiple layers and one or more parasitic patches, each of said patches on one of said layers juxtaposed an area of one of said loops on another of said layers to tune the antenna.

78. (Original) The loop antenna of claim 77 where one or more of said patches is connected to one or more of the antenna loops.

79. (Original) The loop antenna of claim 1 where an outer loop is driven on one side of a substrate and an inner loop is nested in said outer loop and where said inner loop is driven separately than the outer loop.

80. (Original) The loop antenna of claim 1 where an outer loop is driven on one side of a substrate and an inner loop is nested in said outer loop on the opposite side of said substrate.

81. (Original) The loop antenna of claim 1 where each of said loops is driven individually at a different frequency band of operation.

82. (Original) The loop antenna of claim 1 where the antenna operates in cellular frequencies of North America, South America, Europe, Asia or Australia.

83. (Original) The loop antenna of claim 1 where the antenna operates in cellular frequencies of North America, South America, Europe, Asia or Australia that are used for mobile telephones.

84. (Original) The loop antenna of claim 1 where the antenna is embedded in a communication device and operates in the cellular frequencies of North America, South America, Europe, Asia or Australia.

85. (Original) The loop antenna of claim 1 where the antenna operates in a PDA in any PDA frequency of the North America, South America, Europe, Asia or Australia.

86. (Original) The loop antenna of claim 1 wherein said communication device is a portable computer.

87. (Original) The loop antenna of claim 1 where the loops of said antenna are arrayed to have spatial diversity.

88. (Original) The loop antenna of claim 1 where the loops of said antenna are arrayed to have polarization diversity.

89. (Original) The loop antenna of claim 1 where the loops of said antenna are arrayed to have time diversity.

90. (Original) The loop antenna of claim 1 where the loops of said antenna are arrayed to have frequency diversity.

91. (Original) The loop antenna of claim 1 wherein said communication device operates for telemetry.

92. (Original) The loop antenna of claim 1 where a filter network is etched into the antenna to achieve a high Q.

93. (Original) The loop antenna of claim 1 where a filter network is etched into the antenna to achieve a high Q in one of the bands of the antenna.

94. (Original) The loop antenna of claim 1 wherein said loops are arrayed with an area enclosed by one of said loops overlapping an area enclosed by another of said loops to establish said antenna with low SAR.

95. (Original) The loop antenna of claim 1 wherein first ones of said loops have first pads on one layer and second ones of said loops have second pads on another layer where said first pads and said second pads are juxtaposed for coupling between layers.

96. (Original) The loop antenna of claim 1 wherein a first layer supports one or more first pads and a second layer supports one or more second pads connected to a loop where said first pads and said second pads are juxtaposed for coupling between layers.

97. (Original) The loop antenna of claim 1 wherein a first pad on a first layer capacitive couples a second pad on a second layer where said first and second pads are connected to loops to form a filter.

98. (Original) The loop antenna of claim 1 wherein said filter is a high-pass filter.

99. (Original) The loop antenna of claim 1 wherein a first layer on one side of a dielectric base supports one or more first loops and a second layer supports one or more second loops and including vias through said base for connecting said loops.

100. (Original) The loop antenna of claim 1 wherein a first layer on one side of a dielectric base supports a first loop and a second layer supports a second loop and including vias through said base for connecting said first loop and said second loop in a two turn antenna.

101. (Original) The loop antenna of claim 1 wherein one or more of said loops includes one or more segments that tunes the antenna.

102. (Original) The loop antenna of claim 101 wherein said one or more segments have different widths than other segments.

103. (Original) The loop antenna of claim 101 wherein at least one of said segments has a tapered width.

104. (Original) A communication device operating for exchanging energy in bands of radiation frequencies, comprising,
a case for housing the communication device,
a circuit board internal to said case for supporting electrical components including a transceiver unit,
a loop antenna formed of two or more radiation loops wherein,
each loop includes a plurality of electrically conducting segments, each segment having a segment length, where the segments are electrically connected in series to said connection means to form a loop antenna for exchange of energy in one of said bands of radiation frequencies and where said segments are arrayed in a compressed pattern,
said loops are superimposed whereby an area enclosed by one of said loops covers an area enclosed by another of said loops,
connection means for conduction of electrical current between said transceiver unit and said loop antenna.

105. (Original) The communication device of claim 104 wherein said loop antenna and said connection means are internal to said case.

106. (Original) The communication device of claim 104 wherein said loop antenna is affixed to the inside of the case by a pressure sensitive adhesive.

107. (Original) The communication device of claim 104 wherein said loop antenna is injection molded into the case.

108. (Original) The communication device of claim 104 wherein said loop antenna is insert molded into the case.

109. (Original) The communication device of claim 104 where the antenna is connected to the circuit board by a transmission line that is part of the antenna.

110. (Original) The loop antenna of claim 109 where the transmission line alone is not 50 ohms.

111. (Original) The communication device of claim 104 where the antenna is connected to the circuit board through a tang connector.

112. (Original) The communication device of claim 104 where the tang connector alone is not 50 ohms.

113. (Original) The communication device of claim 112 where the tang connector is 50 ohms.

114. (Original) The communication device of claim 113 where the antenna is connected to the circuit board through having a tang where the output impedance of the connector and the tang together is 50 ohms.

115. (Original) The communication device of claim 104 where the antenna is connected to the circuit board through a transmission line and a tang connector where the combined impedance of the transmissions line and tang connector is 50 ohms.

116. (Original) The communication device of claim 104 where the antenna is connected to the circuit board through a transmissions line that is part of the antenna where the antenna and transmission line together have an impedance of 50 ohms.

117. (Original) The communication device of claim 104 where the antenna is connected to the circuit board through a transmission line that is part of the antenna with an impedance that is not 50 ohms.

118. (Original) The communication device of claim 104 where the antenna is connected to the circuit board through a transmission line that is part of the antenna with an impedance that is 50 ohms.

119. (Original) The communication device of claim 104 wherein said loops are nested on the same layer where an area enclosed by a first one of said loops is within an area enclosed by a second one of said loops and where each of said loops has an independent connection to the circuit board.

120. (Original) The communication device of claim 104 wherein each of one or more of said loops provide operation in different frequency bands and where at least one of said loops for a different frequency band has an independent connection to the circuit board.

121. (Original) The communication device of claim 104 wherein said loops are nested where an area enclosed by a first one of said loops is juxtaposed an area enclosed by a second one of said loops and where one of said loops is physically connected to the circuit board and other of said loops are not physically connected to said one of said loops.

122. (Original) The communication device of claim 104 wherein said loops are nested where an area enclosed by a first one of said loops is juxtaposed an area enclosed by a second one of said loops and where only one loop is a drive loop connected at a drive point and all other loops are not physically connected to the drive loop and wherein said unconnected loops are open loops.

123. (Original) The communication device of claim 104 wherein said loops are nested where an area enclosed by a first one of said loops is juxtaposed an area enclosed by a second one of said loops and where only one loop is a drive loop connected at a drive point and all other loops are unconnected loops not physically connected to the drive loop and wherein said unconnected loops are open loops.

124. (Original) The communication device of claim 104 wherein said loops are nested where an area enclosed by a first one of said loops is juxtaposed an area enclosed by a second one of said loops and where only one loop is a drive loop connected at a drive point and all other loops are unconnected loops not physically connected to the drive loop and wherein said unconnected loops are closed loops.

125. (Original) The communication device of claim 104 wherein said loops are nested where an area enclosed by a first one of said loops is juxtaposed an area enclosed by a second one of said loops and where only one loop is a drive loop connected at a drive point and all other loops are unconnected loops not physically connected to the drive loop and wherein said unconnected loops are floating.

126. (Original) The communication device of claim 104 wherein said loops are nested where an area enclosed by a first one of said loops is juxtaposed an area enclosed by a second one of said loops and where only one loop is a drive loop connected at a drive point and all other loops are unconnected loops not physically connected to the drive loop and wherein said unconnected loops are connected to ground.

127. (Original) The communication device of claim 104 wherein said circuit board includes a ground plane and where said loop antenna is in an antenna plane substantially parallel to said ground plane.

128. (Original) The communication device of claim 127 wherein said antenna plane has an offset from said circuit board.

129. (Original) The communication device of claim 128 wherein said offset is less than 10 mm.

130. (Original) The communication device of claim 104 wherein said loops are nested on the same layer where an area enclosed by a first one of said loops is within an area enclosed by a second one of said loops and including first and second connecting pads, each of said pads connected to both said first one and said second one of said loops.

131. (Original) The communication device of claim 130 including a filter connected between said first and second pads.

132. (Original) The communication device of claim 131 wherein said filter is a conductive segment having dimensions establishing a high-pass filter.

133. (Original) A method of making a loop antenna, for use with a communication device operating for exchanging energy in bands of radiation frequencies, comprising the steps of,
forming two or more radiation loops having a tuning parameter on a dielectric substrate to make an instantiation of said loop antenna wherein,
at least one of said loops is arrayed in a compressed pattern,
said loops are superimposed whereby an area enclosed by one of said loops covers an area enclosed by another of said loops;
testing said instantiation of said loop antenna to determine properties of the instantiation of the loop antenna;
modifying said tuning parameter;
repeating said forming, testing and modifying steps until the properties of the loop antenna are acceptable.

134. (Original) The method of claim 133 wherein said tuning parameter is the length of a tuning section connected in series with a loop.

135. (Original) The method of claim 133 wherein said tuning parameter is a gap between loops.

136. (Original) The method of claim 133 wherein said tuning parameter is a width of one or more segments.

137. (Original) The method of claim 136 wherein at least one of said one or more segments is tapered.

138. (Original) The method of claim 133 wherein said tuning parameter is a length of a stub situated internal to a loop.

139. (Original) The method of claim 133 wherein said tuning parameter is a length of a stub situated external to a loop.

140. (Original) The method of claim 133 wherein said tuning parameter is a relative location of juxtaposed loops.

141. (Original) The method of claim 133 wherein said tuning parameter is a length of one or more of said loops.

142. (Original) The method of claim 133 wherein said steps include the step of simulating performance of said antenna.

143. (Original) The method of claim 142 wherein said step of simulating said antenna is repeated after one or more of said modifying steps.

144. (Original) A loop antenna, for use with a communication device, operating for exchanging energy in bands of radiation frequencies, comprising,
connection means for conduction of electrical current,
two or more radiation loops wherein,
each loop includes a plurality of electrically conducting segments, each segment having a segment length, where the segments are electrically connected in series to said connection means to form a loop antenna for exchange of energy in one of said bands of radiation frequencies and where said segments are arrayed in a compressed pattern,
said loops are superimposed whereby an area enclosed by one of said loops covers an area enclosed by another of said loops,
a tuning element for tuning said loop antenna.
